(19) United States
(12) Patent Application Publication
(10) Pub. No.: US 2025/0114936 A1
(43) Pub. Date: Apr. 10, 2025

(54) OPERATION INPUT DEVICE AND OPERATION CONSOLE DEVICE

(71) Applicant: SONY GROUP CORPORATION, TOKYO (JP)

(72) Inventor: KAZUHITO WAKANA, TOKYO (JP)

(21) Appl. No.: 18/729,744

(22) PCT Filed: Nov. 30, 2022
(86) PCT No.: PCT/JP2022/044232

§ 371 Date: Jul. 17, 2024

(30) Foreign Application Priority Data
Jan. 25, 2022 (JP) 2022-009750

(51) Int. Cl. B25J 9/16; B25J 13/02

(52) U.S. Cl. CPC B25J 9/1612; B25J 13/02

(57) ABSTRACT

Provided is an operation input device in which a distal end is downsized and a movable range is widened by a cable drive mechanism. The operation input device includes: a handle portion that can be gripped and operated; a shaft that supports the handle portion about a roll axis and a pitch axis at a distal end, and has a longitudinal axis that is a yaw axis orthogonal to the roll axis and the pitch axis; and a cable transmission mechanism that transmits power between the handle portion and a root side of the shaft portion using a cable. The operation input device includes a first motor and a second motor, and further includes a drive unit that generates a driving force for a gripping operation and a rotation operation of the handle portion.

### TECHNICAL FIELD

The technology disclosed in the present specification (hereinafter, “the present disclosure”) relates to a manipulator type operation input device and an operation console device using the operation input device.

### BACKGROUND ART

A manipulator type operation input device is effective for remote operation and 3D operation on a screen. For example, there has been proposed an operation device for a surgical manipulator including an arm unit, a wrist unit connected to a distal end portion of the arm unit, an operation unit provided at a distal end portion of the wrist unit, a plurality of motors that respectively drive a plurality of joints of the arm unit and a plurality of joints of the wrist unit, an input device including a plurality of rotation angle sensors that respectively detect rotation angles of the plurality of motors, and a controller that controls operations of the plurality of motors on the basis of the rotation angles detected by the plurality of rotation angle sensors (see Patent Document 1).

For example, in order to precisely operate a surgical tool such as forceps in a master-slave surgical system, a master-side operation input device requires a total of seven degrees of freedom including one degree of freedom for gripping in addition to three degrees of freedom for translation and three degrees of freedom for rotation. In addition, in order to accurately perform this type of operation, it is necessary to arrange an actuator that drives each axis in order to present a force sense and a tactile sense to the operator in addition to visual information and auditory information. However, particularly in the configuration in which the motor is disposed for each joint (see, for example, Patent Document 1), a size of the operation input device increases, and a mechanism near the distal end for instructing gripping operation becomes complicated and heavy. In general, the gimbal structure is supported by the distal end of the distal end portion arm that realizes three rotational degrees of freedom and one gripping degree of freedom. In addition, under the operation in which the operator operates the operation input device with each of the left and right hands, a mechanism in the vicinity of the distal end of the operation input device becomes large, so that the operator cannot perform the operation with both hands close to each other or the operation using the hand rest, and it becomes difficult to perform the ultra-precision operation such as a micro surgery.

### CITATION LIST

### Patent Document

Patent Document 1: Japanese Patent Application Laid-Open No. 2020-103896

### SUMMARY OF THE INVENTION

### Problems to be Solved by the Invention

An object of the present disclosure is to provide an operation input device and an operation console device that can perform haptic presentation and are configured to be small and lightweight.

### Solutions to Problems

The present disclosure has been made in view of the above problems, and a first aspect thereof is an operation input device, including:
a handle portion that can be gripped and operated;
a shaft that supports the handle portion about a roll axis and a pitch axis at a distal end, and has a longitudinal axis that is a yaw axis orthogonal to the roll axis and the pitch axis; and
a cable transmission mechanism that transmits power between the handle portion and a root side of the shaft portion using a cable.

The operation input device according to the first aspect further includes a drive unit that includes a first motor and a second motor and generates a driving force for a gripping operation and a rotation operation of the handle portion. Furthermore, the cable transmission mechanism includes a first cable loop and a second cable loop that are inserted into the hollow shaft and transmit driving forces of the first motor and the second motor, respectively. Furthermore, the handle portion includes a first gripper and a second gripper that perform an opening/closing operation, a first rotation unit that supports the first gripper and rotates about the roll axis by driving of the first cable loop, and a second rotation unit that supports the second gripper and rotates about the roll axis by driving of the second cable loop.

Then, the first gripper and the second gripper simultaneously rotate about the roll axis by the first rotation unit and the second rotation unit rotating in the same direction, while
the first gripper and the second gripper open and close by the first rotation unit and the second rotation unit rotating in opposite directions.

Further, a second aspect of the present disclosure is an operation console device including
an operation input device corresponding to at least one of left and right hands of an operator; and
a master arm that holds the operation input device.

The operation input device included in the operation console device according to the second aspect may be the same as the operation input device according to the first aspect.

The master arm includes:
a tilt link that supports the operation input device;
a panning operation unit that causes the operation input device to perform a panning operation;
a first tilting operation unit that causes the operation input device to perform a tilting operation about a vicinity of a root of the tilting link;
a second tilting operation unit that causes the operation input device to perform a tilting operation about the vicinity of the distal end of the tilting link; and
a yaw operation unit that rotates the operation input device about a yaw axis.

The operation console device according to the second aspect may further include a hand rest or a wrist rest on which an operator places a hand or a wrist when operating the operation input device.

### Effects of the Invention

According to the present disclosure, it is possible to provide the operation input device and the operation console device in which the distal end is downsized and the movable range is widened by the cable drive mechanism.

Note that the effects described in the present specification are merely examples, and the effects to be brought by the present disclosure are not limited thereto. Also, the present disclosure may further provide additional effects in addition to the effects described above in some cases.

Still other objects, features, and advantages of the present disclosure will become apparent from a more detailed description based on embodiments as described later and the accompanying drawings.

### BRIEF DESCRIPTION OF DRAWINGS

FIG. 1 is a diagram illustrating a functional configuration example of a surgical system 100.

FIG. 2 is a diagram illustrating a configuration example of an operation input device 200.

FIG. 3 is an enlarged diagram of a vicinity of a distal end of a shaft 202.

FIG. 4 is a diagram illustrating a cross section near a distal end of the shaft 202.

FIG. 5A is an exploded diagram of a handle portion 201.

FIG. 5B is a diagram illustrating a state in which a first output capstan 261 and a second output capstan 262 rotate about a roll axis.

FIG. 6 is an enlarged diagram illustrating a structure near a root of the shaft 202.

FIG. 7 is a diagram illustrating a wire layout of the first output capstan 261 and the second output capstan 262.

FIG. 8 is a diagram illustrating a principle of rotating the handle portion 201 about a pitch axis using a third motor 233.

FIG. 9 is a diagram illustrating a state in which the handle portion 201 is rotated about the pitch axis by driving a third input capstan 253.

FIG. 10 is a diagram illustrating a state in which the handle portion 201 is rotated about the pitch axis by driving the third input capstan 253.

FIG. 11 is a diagram illustrating a state in which the handle portion 201 is rotated about the pitch axis by driving the third input capstan 253.

FIG. 12 is a perspective view of the handle portion 201 illustrating variables used in an input/output relationship in the operation input device 200.

FIG. 13 is a top view of the handle portion 201 illustrating variables used in an input/output relationship in the operation input device 200.

FIG. 14 is a diagram illustrating variables used in an input/output relationship in the operation input device 200 on a side view of the handle portion 201.

FIG. 15 is a diagram summarizing definitions of variables used in an input/output relationship in the operation input device 200.

FIG. 16 is a diagram illustrating how the handle portion 201 rotates about the pitch axis with respect to the shaft 202.

FIG. 17 is a diagram illustrating how the handle portion 201 rotates about the pitch axis with respect to the shaft 202.

FIG. 18 is a diagram illustrating how the handle portion 201 rotates about the pitch axis with respect to the shaft 202.

FIG. 19 is a diagram illustrating a state in which the handle portion 201 rotates about the roll axis with respect to the shaft 202.

FIG. 20 is a diagram illustrating a state in which the handle portion 201 rotates about the roll axis with respect to the shaft 202.

FIG. 21 is a diagram illustrating a state in which the handle portion 201 rotates about the roll axis with respect to the shaft 202.

FIG. 22 is a diagram illustrating a state in which a first gripper 211 and a second gripper 212 of the handle portion 201 perform an opening/closing operation.

FIG. 23 is a diagram illustrating a state in which the first gripper 211 and the second gripper 212 of the handle portion 201 perform an opening/closing operation.

FIG. 24 is a diagram illustrating a state in which the handle portion 201 rotates about a yaw axis.

FIG. 25 is a diagram illustrating a state in which the handle portion 201 rotates about a yaw axis.

FIG. 26 is a diagram illustrating a state in which the handle portion 201 rotates about a yaw axis.

FIG. 27 is a diagram illustrating a state in which the entire operation input device 200 is rotated about the yaw axis using a device holder 2700.

FIG. 28 is a diagram illustrating a state in which the entire operation input device 200 is rotated about the yaw axis using the device holder 2700.

FIG. 29 is a diagram illustrating a state in which the entire operation input device 200 is rotated about the yaw axis using the device holder 2700.

FIG. 30 is a diagram illustrating a structure in the vicinity of the handle portion 201 configured such that a roll axis and a pitch axis intersect.

FIG. 31 is a diagram illustrating a structure in the vicinity of the handle portion 201 configured such that the roll axis and the pitch axis intersect.

FIG. 32 is a diagram illustrating components of the handle portion 201 in an exploded manner.

FIG. 33 is an enlarged view 33 illustrating a structure near a root of the shaft 202.

FIG. 34 is a diagram illustrating a structure of the handle portion 201 including a torsion spring.

FIG. 35 is a diagram illustrating a handle portion 3500 according to a modification.

FIG. 36 is a diagram illustrating a usage example of the handle portion 3500.

FIG. 37 is a diagram illustrating an application example in which the operation input device 200 is applied to a master arm 3700.

FIG. 38 is a diagram illustrating a degree-of-freedom configuration in which the master arm 3700 supports the operation input device 200.

FIG. 39 is a diagram illustrating a series of operations of panning the operation input device 200.

FIG. 40 is a diagram illustrating a series of operations of tilting the operation input device 200 with respect to a master arm body 3701.

FIG. 41 is a diagram illustrating a series of operations of tilting the operation input device 200 at a current position.

FIG. 42 is a diagram illustrating a series of operations of rotating the operation input device 200 about the yaw axis.

FIG. 43 is a diagram illustrating a series of operations in which the operation input device 200 mounted on the master arm 3700 rotates the handle portion 201 about the pitch axis.

FIG. 44 is a diagram illustrating a series of operations in which the operation input device 200 mounted on the master arm 3700 rotates the handle portion 201 about the roll axis.

FIG. 45 is a diagram illustrating an external configuration of an operation console device 4500 to which the operation input device 200 is applied.

FIG. 46 is a diagram illustrating an external configuration of an operation console device 4600 according to a modification.

FIG. 47 is a diagram illustrating an external configuration of an operation console device 4700 according to another modification.

### MODE FOR CARRYING OUT THE INVENTION

Hereinafter, the present disclosure will be described in the following order with reference to the drawings.

A. System Configuration

B. Overview of the Present Disclosure

C. Specific Configuration of Operation Input Device
C-1. Overall Configuration
C-2. Structure of Handle Portion
C-3. Structure of Drive Unit
C-4. Input/output relationship between drive unit and handle portion
C-5. Operation of Handle Portion
C-6. Yaw axis operation of handle portion

D. Modification
D-1. Structure in which roll axis and pitch axis intersect
D-2. Backlash-free Design
D-3. Handle portion structure

E. Application example
E-1. Application Example to Master Arm E-2. Application Example to Operation Console Device

E-2. Modification of Operation Console Device

### A. System Configuration

In general, surgical operation is a difficult task performed by the operator's sensorimotor. In particular, in surgery using a microscopic image, it is necessary for an operator to perform a precise operation while suppressing tremor of a hand. Recently, robotics technology has also been introduced into the medical field. For example, a surgical system has been proposed in which an operator operates a manipulator on the basis of a surgical site image and remotely operates a robot on the surgical tool side according to an operation amount to treat a patient. Furthermore, in a case where surgery is performed by remote control, haptic presentation, that is, a “haptics device” for presenting a haptic sense or a tactile sense to the operator is essential in addition to visual information and auditory information.

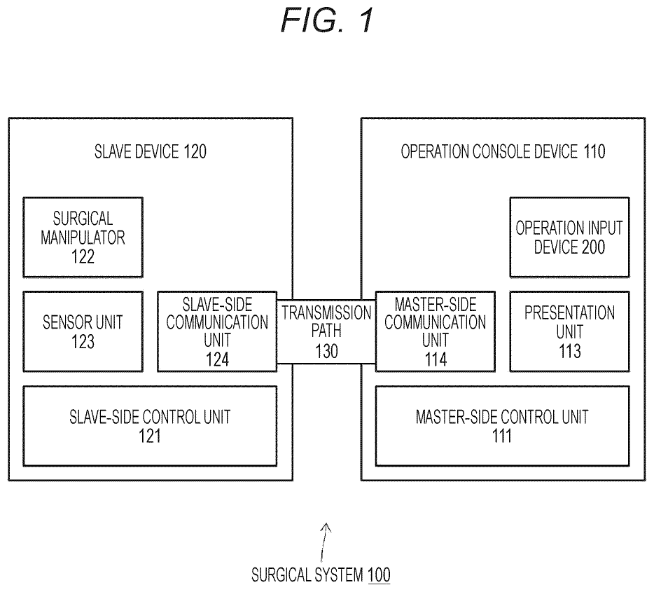

FIG. 1 schematically illustrates a functional configuration example of a surgical system 100. The illustrated surgical system 100 is a master-slave system, and includes an operation console device 110 as a master and a slave device 120 that operates a surgical tool. A user such as an operator operates the operation console device 110, and controls driving of the surgical manipulator 122 according to the user's operation on the slave side installed in an operating room, thereby performing surgery.

The operation console device 110 is installed outside the operating room (alternatively, a place separated from an operating table in the operating room), for example, and a user (operator) remotely operates the slave device 120. The slave device 120 includes a surgical manipulator 122 installed near the operating table, and performs surgery on a patient laid on the operating table in accordance with an instruction from the operation console device 110. Examples of the surgery described herein include laparoscopic surgery, coeloscopic surgery, brain surface surgery, and eye or fundus surgery. The operation console device 110 and the slave device 120 are interconnected through a transmission path 130. The transmission path 130 is desirably capable of performing signal transmission with a low delay using, for example, a medium such as an optical fiber.

The operation console device 110 includes a master-side control unit 111, an operation input device 200, a presentation unit 113, and a master-side communication unit 114. The operation console device 110 operates under the overall control of the master-side control unit 111.

The operation input device 200 is an input device for a user (operator or the like) to perform a remote operation or an on-screen 3D operation on a surgical manipulator 122 (described later) that drives a surgical tool such as forceps in the slave device 120. In the present embodiment, it is assumed that the operation input device 200 can perform operations of three degrees of freedom of translation for translating the surgical tool, three degrees of freedom of rotation for changing a posture of the surgical tool, and one degree of freedom of gripping such as an opening and closing operation of the forceps.

The presentation unit 113 presents information regarding surgery performed on the slave device 120 to a user (operator) operating the operation input device 200 on the basis of sensor information mainly acquired by a sensor unit 123 (described later) on the slave device 120 side.

For example, in a case where the sensor unit 123 on the slave device 120 side is equipped with an RGB camera for observing a surface of an affected part, an RGB camera for capturing a microscopic image, an endoscope in laparoscopic or coeloscopic surgery, or an interface for capturing captured images of these cameras, and these image data are transferred to the operation console device 110 with a low delay through the transmission path 130, the presentation unit 113 displays a captured image of the affected part of the affected part in real time on a screen using a monitor display or the like.

Furthermore, in a case where the sensor unit 123 is equipped with a function of measuring a force sense such as an external force or a moment acting on the surgical tool operated by the surgical manipulator 122, and such force sense information is transferred to the operation console device 110 with a low delay through the transmission path 130, the presentation unit 113 performs force sense presentation to the user (operator). The haptic presentation function of the presentation unit 113 is incorporated and implemented in the operation input device 200. Specifically, the presentation unit 113 performs haptic presentation to the user (operator) by driving a grip portion having, for example, three degrees of freedom of rotation and one degree of freedom of holding of the distal end of the operation input device 200 with a motor. In the present embodiment, with use of the cable driving system, the motor for driving is disposed to be separated from the grip portion at the distal end, so that downsizing and weight reduction and wide movable range of the grip portion are realized, but details of this point will be described later.

The master-side communication unit 114 performs a signal transmission/reception process with the slave device 120 through the transmission path 130 under the control of the master-side control unit 111. For example, in a case where the transmission path 130 includes an optical fiber, the master-side communication unit 114 includes an electro-optical conversion unit that converts an electrical signal transmitted from the operation console device 110 into an optical signal, and a photoelectric conversion unit that converts an optical signal received from the transmission path 130 into an electrical signal. The master-side communication unit 114 transfers an operation command for the surgical manipulator 122 input by the user (operator) through the operation input device 200 to the slave device 120 through the transmission path 130. Furthermore, the master-side communication unit 114 receives the sensor information transmitted from the slave device 120 through the transmission path 130.

On the other hand, the slave device 120 includes a slave-side control unit 121, a surgical manipulator 122, a sensor unit 123, and a slave-side communication unit 124. The slave device 120 operates in accordance with an instruction from the operation console device 110 under the overall control of the slave-side control unit 121.

The surgical manipulator 122 is, for example, an arm type surgical robot having an articulated link structure, and a surgical tool is mounted as an end effector on a tip end (or the distal end). Examples of the surgical tools include forceps, pneumoperitoneum tubes, energy treatment tools, tweezers, and retractors. The slave-side control unit 121 interprets the operation command transmitted from the operation console device 110 through the transmission path 130, converts the operation command into a drive signal of an actuator that drives the surgical manipulator 122, and outputs the drive signal. Then, the surgical manipulator 122 operates on a basis of the drive signal from the slave-side control unit 121.

The sensor unit 123 includes a plurality of sensors for detecting a situation in an affected part of surgery performed by the surgical manipulator 122 and the surgical manipulator 122, and further includes an interface for taking in sensor information from various sensor devices installed in the operating room. For example, the sensor unit 123 includes a force torque sensor (FTS) for measuring an external force and a moment applied during surgery on a surgical tool mounted on a distal end (distal end) of the surgical manipulator 122. In addition, the sensor unit 123 is equipped with an RGB camera for observing a surface of an affected part during surgery by the surgical manipulator 122, an RGB camera for capturing a microscopic image, an endoscope in laparoscopic or coeloscopic surgery, or an interface for capturing captured images of these cameras.

The slave-side communication unit 124 performs a signal transmission/reception process with the operation console device 110 through the transmission path 130 under the control of the slave-side control unit 121. For example, in a case where the transmission path 130 includes an optical fiber, the slave-side communication unit 124 includes an electro-optical conversion unit that converts an electrical signal transmitted from the slave device 120 into an optical signal, and a photoelectric conversion unit that converts an optical signal received from the transmission path 130 into an electrical signal.

The slave-side communication unit 124 transfers the haptic data of the surgical tool acquired by the sensor unit 123, an RGB camera for observing the surface of the affected part, an RGB camera for capturing a microscopic image, and a captured image of an endoscope or the like in laparoscopic or coeloscopic surgery to the operation console device 110 through the transmission path 130. Furthermore, the slave-side communication unit 124 receives an operation command for the surgical manipulator 122 transmitted from the operation console device 110 through the transmission path 130.

### B. OVERVIEW OF THE PRESENT DISCLOSURE

The operation input device 200 is an input device for a user to perform a remote operation or a 3D operation on a screen. In the case of remotely operating a surgical tool such as forceps mounted as an end effector of the surgical manipulator 122 as in the present embodiment, the operation input device 200 has three degrees of freedom of translation for translating the surgical tool, three degrees of freedom of rotation for changing the posture of the surgical tool, and one degree of freedom of gripping such as opening and closing operation of the forceps. In addition, in the configuration in which the motor is arranged for each joint of the operation input device 200 (see, for example, Patent Document 1), a grip portion having, for example, three degrees of freedom of rotation and one degree of freedom of gripping of the distal end is driven by the motor to perform haptic presentation to a user (operator).

As the operation input device 200, a gimbal structure in which a grip portion is supported by a distal end of an arm is generally used (see, for example, Patent Document 1). However, the motor is disposed for each joint of the grip portion, and then the mechanism is complicated, the size increases, and the weight increases. In such a case, the following technical problems (1) to (3) are caused.

(1) Operation Cannot be Performed with Both Hands Brought Close to Each Other

The mechanism near the grip portion is large and bulky. For this reason, in a case where the right and left hands respectively operate the individual grip portions, even if the right and left hands are brought close to each other, the mechanisms of the right and left arms interfere with each other, and the right and left hands have to be separated to some extent and operated. Since there is a difference between a distance between the left and right end effectors on the surgical manipulator 122 side to be operated and a distance between the left and right of the operator on the master side, the operator needs to perform the operation by converting the difference in the brain, and the intuitiveness of the operation is impaired.

### (2) Hand Rest (or Wrist Rest) Cannot be Placed

For example, in fine work such as microscopic surgery, it is effective to perform work with a wrist or a part of a hand installed in an environment in order to stabilize the operator's hand. In a case where the size of the grip portion is large and the mechanism is heavy, the grip portion is designed and manufactured on the premise that a forearm of the operator is placed on the arm rest to perform operation. Since there is a risk of interference with the mechanism around the grip portion, the hand rest and the wrist rest cannot be disposed, and thus the hand of the operator cannot be stabilized.

### (3) Arm Distal End Portion is Heavy

Since there is a gimbal structure including a motor, a brake, and an encoder at the distal end of the arm supporting the grip portion, the distal end portion of the arm becomes heavy. Since the arm distal end portion is heavy, large motor torque and counterbalance are required for gravity compensation. As the output of the motor increases, the power consumption of the operation input device 200 increases, the resolution of the output torque becomes coarse, and fine force control becomes difficult. In addition, since a heavy object is disposed at the distal end portion, the moment of inertia viewed from the root side of the arm increases, and the response characteristics of the mechanism deteriorate.

Therefore, in the present disclosure, the operation input device 200 has a structure in which the rotation axes of the roll, pitch, yaw, and grip arranged in the vicinity of the grip portion are arranged, and the driving motor is arranged at the root portion (or proximal end) of the arm instead of the grip portion of the arm distal end, and the motor torque is transmitted using the cable drive mechanism. According to the present disclosure, it is possible to downsize the grip portion at the distal end of the operation input device 200 and realize a wide movable range, and there are the following advantages (1) to (3).

(1) Operation with both hands close to each other is possible

With application of the cable drive mechanism to the operation input device 200, the mechanism in the vicinity of the grip portion at the distal end is downsized. As a result, in a case where the individual grip portions are operated with the left and right hands, it is possible to perform the operation by bringing both hands close to each other, so that unnecessary brain conversion is unnecessary and the operator can easily perform the hand eye coordination.

(2) Hand rest (or wrist rest) is arrangeable With downsizing the mechanism in the vicinity of the grip portion at the distal end of the operation input device 200, it is possible to dispose the hand rest and the wrist rest without interfering with peripheral mechanisms. As a result, the operator places the wrist or a part of the hand in the environment on the hand rest or the wrist rest, stabilizes the hand, and operates the operation input device 200, so that fine work such as microscopic surgery can be accurately performed.

(3) The distal end portion is reduced in weight. With application of the cable drive mechanism to drive the grip portion, heavy objects such as a motor, a brake, and an encoder are not disposed at the distal end of the operation input device 200. As a result, large motor torque and counterbalance for gravity compensation become unnecessary. Since an output of the motor can be reduced, the power consumption of the entire operation input device 200 is reduced, the resolution of the output torque becomes fine, and fine force control becomes possible. In addition, with reduction in the weight of the distal end portion, a moment of inertia as viewed from the root side of the operation input device 200 is reduced, and the response characteristics of the mechanism are improved.

In addition, the operation input device 200 to which the present disclosure is applied has the following effects (4) to (8) by applying the cable drive mechanism to drive the grip portion.

(4) Since no electric component such as a motor is disposed at the distal end, the grip portion is downsized.

(5) Since there is no electric component such as a motor at the distal end portion that supports the grip portion, there is no electric harness or the like that extends across the shaft, a rotation movable range of the shaft is increased, and the number of internal disturbance elements is reduced.

(6) With placement of the motor on the root side, high output is possible while the distal end portion is compact.

(7) Since the electric component is disposed far from the hand of the operator who operates the grip portion, a risk of burns due to heat generation of the electric component is reduced.

(8) Since the electric components are eliminated, the link shape of the grip portion is simplified, and the drape is easily applied as necessary (the drape is hardly applied in the gimbal structure).

### C. SPECIFIC CONFIGURATION OF OPERATION INPUT DEVICE

### C-1. Overall Configuration

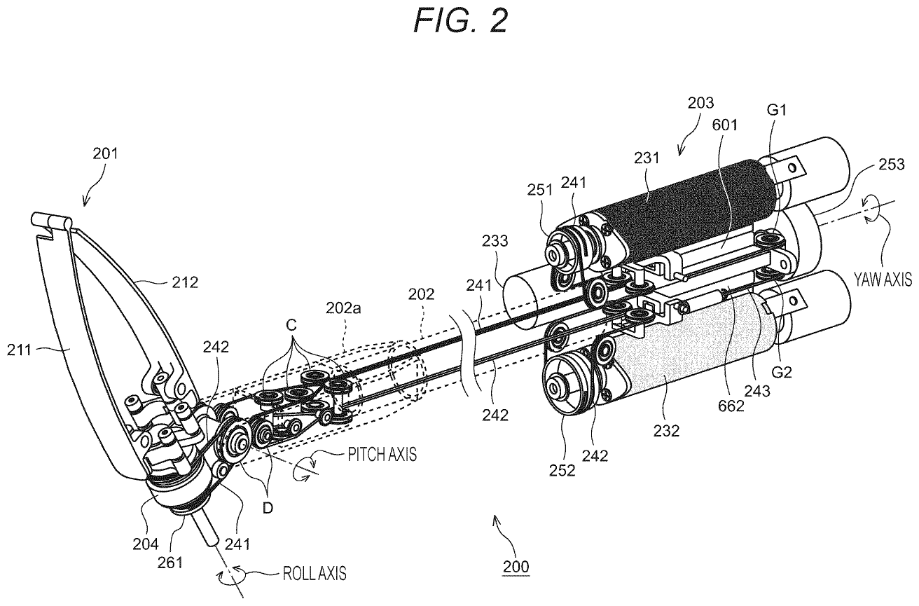

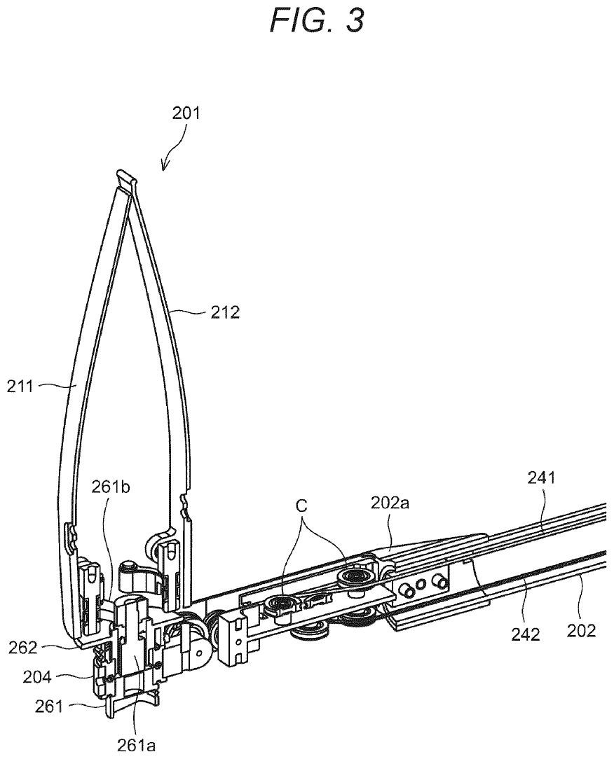

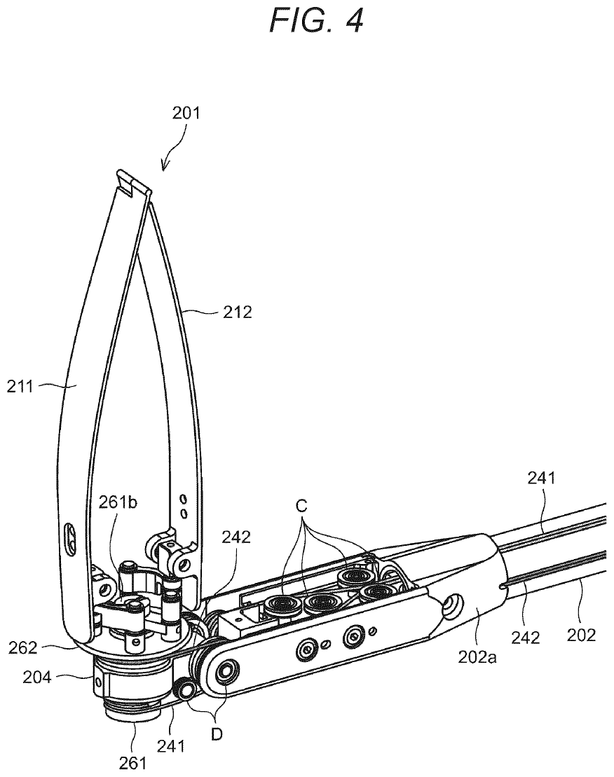

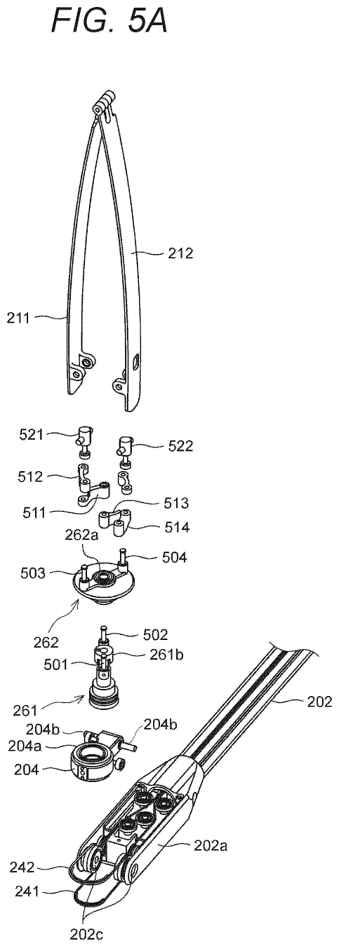

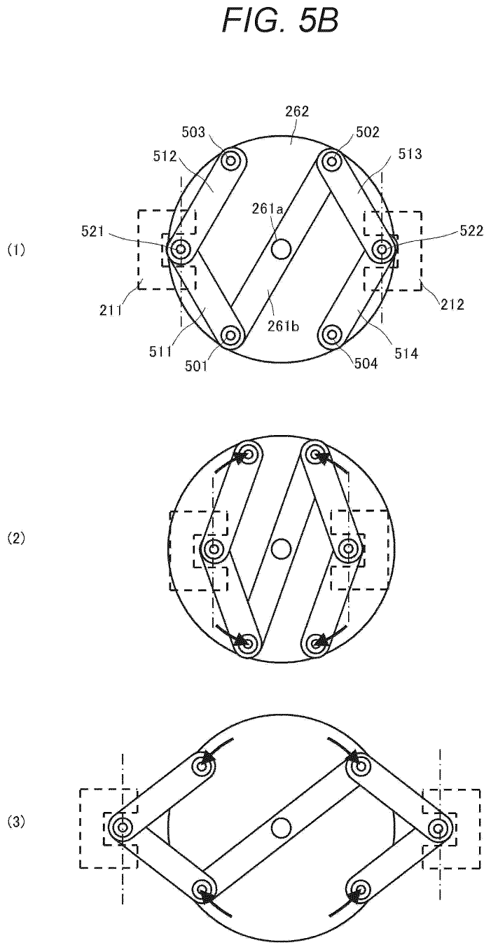

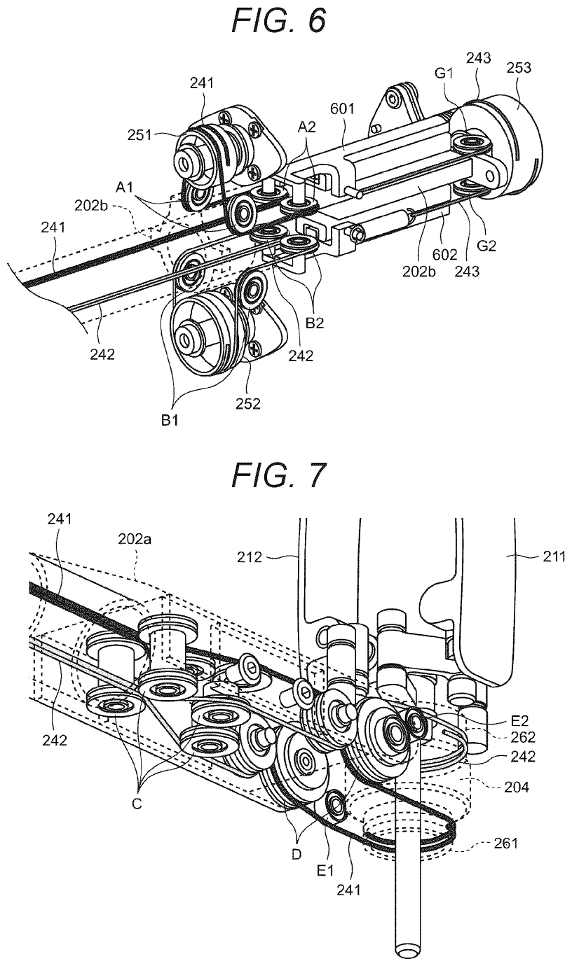

FIG. 2 illustrates an overall configuration example of the operation input device 200 to which the present disclosure is applied. The operation input device 200 is used, for example, in a master-slave surgical system (see FIG. 1) in order for an operator on the master side to perform remote operation of the surgical manipulator 122 and perform haptic presentation to the operator. Further, FIG. 3 illustrates an enlarged view of the vicinity of the distal end of the shaft 202, and FIG. 4 illustrates a cross-sectional view of the vicinity of the distal end of the shaft 202. Also, FIG. 5A is an exploded view of the handle portion 201. In addition, FIG. 6 illustrates an enlarged structure near the root of the shaft 202. Hereinafter, the configuration of the operation input device 200 will be described with reference to FIGS. 2 to 6.

The operation input device 200 includes a shaft 202 having a longitudinal axis (hereinafter, defined as a yaw axis), a handle portion 201 at a tip end (or the distal end) of the shaft 202, and a drive unit 203 at the other end (or root) of the shaft 202. The shaft 202 is a hollow cylindrical structure into which a cable for transmitting a drive unit of the drive unit 203 is inserted, and has a socket 202a (see FIGS. 3 and 4) for attaching the handle portion 201 at the tip end (or the distal end), and a base 202b (see FIG. 6) for mounting the drive unit 203 on the other end (or root) side. In FIG. 2, a middle of the shaft 202 is omitted. A length of the shaft 202 is arbitrary, and may be appropriately determined according to, for example, operability and preference of the operator and other design matters.

A wrist element 204 pivotable about a first axis (hereinafter, defined as a pitch axis) orthogonal to the yaw axis is attached to the socket 202a at the tip (or the distal end) of the shaft 202. Then, the wrist element 204 supports the handle portion 201 so as to be rotatable about a second axis (hereinafter, defined as a roll shaft) orthogonal to the first axis. Therefore, it can be said that the handle portion 201 has rotational degrees of freedom about two axes of the pitch axis and the roll axis with respect to the shaft 202.

The handle portion 201 includes a first gripper 211 and a second gripper 212 used for a gripping operation. The first gripper 211 and the second gripper 212 are rotatably coupled with a gripping shaft at the upper end. A traction (pre-tension) from the cables (the first cable loop and the second cable loop) driven by the drive unit 203 provides torque in the opening direction to the first gripper 211 and the second gripper 212. Therefore, the operator operating the operation input device 200 can operate to grip the first gripper 211 and the second gripper 212. Further, the operator can perform an operation of turning the handle portion 201 about the pitch axis (or the left-right direction) or tilting the handle portion about the yaw axis (or in the vertical direction) with respect to the shaft 202 while gripping the first gripper 211 and the second gripper 212.

The drive unit 203 includes a first motor 231, a second motor 232, and a third motor 233 for realizing three degrees of freedom of an opening/closing operation of the handle portion 201, a rotation operation of the handle portion 201 with respect to the shaft 202 around a roll axis, and a rotation operation around a pitch axis. The first motor 231, the second motor 232, and the third motor 233 are mounted on the base 202b on the root side of the shaft 202. The drive unit 203 transmits the output of each of the motors 231 to 233 by a cable and drives the handle portion 201 in each of the axial directions of the roll axis, the pitch axis, and the grip axis, so that it is possible to present a sense of force to the operator who operates the operation input device 200.

As can be seen from FIG. 2, the output shaft of the first motor 231 is attached with a first input capstan 251 that winds a first cable loop 241 that transmits the output of the first motor 231, and an encoder (not shown) that detects the rotation angle of the output shaft of the first motor 231. In addition, a second input capstan 252 that winds a second cable loop 242 that transmits the output of the second motor 232 and an encoder (not illustrated) that detects a rotation angle of the output shaft of the second motor 232 are attached to the output shaft of the second motor 232. Also, as can be seen from FIG. 6, the output shaft of the third motor 233 is attached with a third input capstan 253 that winds a third cable 243 for transmitting the output of the third motor 233, and an encoder (not shown) that detects the rotation angle of the output shaft of the third motor 233.

As can be seen in FIGS. 2 and 6, the first cable loop 241 wound around the first input capstan 251 is redirected through the idler pulley A1 and the idler pulley A2 and inserted into the hollow shaft 202. Then, as can be seen from FIGS. 3 and 4, the first cable loop 241 is redirected through an idler pulley group C and an idler pulley group D on the distal end side of the shaft 202, and then wound around the first output capstan 261 on the handle portion 201 side.

Also, as can be seen from FIGS. 2 and 6, the second cable loop 242 wound around the second input capstan 242 is redirected through an idler pulley B1 and an idler pulley B2 and inserted into the hollow shaft 202. Then, as can be seen from FIGS. 3 and 4, the second cable loop 242 is redirected through the idler pulley group C and the idler pulley group D on the distal end side of the shaft 202, and then wound around the second output capstan 262 on the handle portion 201 side.

The wire layout of the first output capstan 261 and the second output capstan 262 will be supplementarily described with reference to FIG. 7. An idler pulley E1 is disposed on either an outward path or a return path (here, the outward path is assumed) of the first cable loop 241. The idler pulley E1 moves the course of the first cable loop 241 wound from an idler pulley at the most distal end (on the distal end side) of the idler pulley group D in the roll axis direction so as not to overlap the return path. As a result, the outward path and the return path of the first cable loop 241 can be overlapped around the roll axis and simultaneously wound around the first output capstan 261, and the rotation movable range of the first output capstan 261 around the roll axis can be maximized. The idler pulley E1 is connected to the socket 202a.

Similarly, the idler pulley E2 is disposed on either the outward path or the return path (here, the return path is assumed) of the second cable loop 242. The idler pulley E2 moves the course of the second cable loop 242 wound from the idler pulley at the most distal end (on the distal end side) of the idler pulley group D in the roll axis direction so as not to overlap the outward path. As a result, the outward path and the return path of the second cable loop 242 can be overlapped around the roll axis and simultaneously wound around the second output capstan 262, and the rotation movable range around the roll axis of the second output capstan 262 can be maximized. The idler pulley E2 is also connected to the socket 202a.

Note that the idler pulley A1, the idler pulley A2, the idler pulley B1, and the idler pulley B2 are rotatably connected to the base portion 202b (Strictly, as illustrated in FIG. 6, the idler pulleys A1 and A2 are fixed to the first slider 601 together with the first motor 231, and the idler pulleys B1 and B2 are fixed to the second slider 602 together with the second motor 232. The first slider 601 and the second slider 602 will be described later.). The idler pulley A1 and the idler pulley A2 have a role of winding the first cable loop 241 from the first input capstan 251, changing the direction, and inserting the cable loop into the shaft 202, but are not particularly limited to the illustrated configuration and arrangement as long as the idler pulley A1 and the idler pulley A2 have the same role. Furthermore, the idler pulley B1 and the idler pulley B2 have a role of winding the second cable loop 242 from the second input capstan 252, changing the direction, and inserting the second cable loop into the shaft 202. However, the idler pulley B1 and the idler pulley B2 are not particularly limited to the illustrated configuration and arrangement as long as the idler pulley B1 and the idler pulley B2 play the same role.

Furthermore, the idler pulley group C and the idler pulley group D are both connected to the socket 202a on the distal end side. The idler pulley group C serves to wind the first cable loop 241 and the second cable loop 242 from the inside of the shaft 202. In addition, the idler pulley group D has a role of redirecting the first cable loop 241 and the second cable loop 242 wound by the idler pulley group C from the inside of the shaft 202 and winding them around the first output capstan 261 and the second output capstan 262. The idler pulley group C is a set of idler pulleys that rotate about an axis orthogonal to the pitch axis and the yaw axis. Furthermore, the idler pulley group D is a set of idler pulleys that rotate about an axis parallel to the pitch axis, and a pair of idler pulleys at the most distal end (distal end side) of the idler pulley group D rotates about the pitch axis. However, the idler pulley group C and the idler pulley group D are not particularly limited to the illustrated configuration and arrangement as long as they play the same role.

### C-2. Structure of Handle Portion

Next, the structure of the handle portion 201 will be described in detail.

Referring to FIG. 5A, the wrist element 204 has a pair of protrusions 204b configuring a pitch axis on the root side. A pair of shaft holes 202c is drilled in the pitch axis direction at the distal end of the socket 202, and the wrist element 204 is rotatably supported around the pitch axis by attaching a pair of protrusions 204b coaxial with the pitch axis to these shaft holes 202c. In addition, the wrist element 204 has a cylindrical opening that is substantially coaxial with the roll axis on the distal end side. The second output capstan 262 is supported by the cylindrical opening of the wrist element 204 through a bearing 204a so as to be rotatable about the roll axis. In addition, a circular opening centered on the roll axis is drilled in the center of the second output capstan 262. The first output capstan 261 is supported in a central opening of the second output capstan 262 through a bearing 262a so as to be rotatable about the roll axis. Thus, the first output capstan 261 and the second output capstan 262 are supported so as to be rotatable about the roll axis independently of one another.

Further, referring to FIGS. 3 and 5A, the first output capstan 261 is provided with a shaft portion 261a protruding in the roll axis direction at the center. The shaft portion 261a emerges from the central opening of the second output capstan 262, and a rotor 261b linear in the diametrical direction is attached to the distal end thereof. The rotor 261b is fixed to the shaft portion 261a, and these are integrally rotated about the roll axis. The first output capstan 261 rotates by the rotational force transmitted by the first cable loop 241, and then the rotor 261b rotates integrally with the first output capstan 261 about the roll axis.

A pair of protrusions 501 and 502 aligned in the diametrical direction are provided at both ends of the rotor 261b. In addition, a pair of protrusions 503 and 504 arranged in another diametrical direction is also formed on the upper surface of the second output capstan 262. One end of a link 511 is rotatably attached to the projection 501, one end of a link 512 is rotatably attached to the projection 503, and the other ends of the link 511 and the link 512 are rotatably connected by using a rotary joint 521. The link 511 and the link 512 are one-joint link structures having a V shape opened on the roll axis side. On the other hand, one end of a link 513 is rotatably attached to the projection 502, one end of the link 514 is rotatably attached to the projection 504, and the other ends of the link 513 and the link 514 are rotatably connected to each other by using a rotary joint 522. The link 513 and the link 514 are one-joint link structures having a V shape facing the link 511 and the link 512 and opened on the roll axis side.

As already mentioned, the first gripper 211 and the second gripper 212 are rotatably coupled at the gripping axis of the upper end. A lower end of the first gripper 211 is rotatably attached to an upper portion of the rotary joint 521 connecting the link 511 and the link 512. Also, a lower end of the second gripper 212 is rotatably attached to an upper portion of the rotary joint 522 that connects the link 513 and the link 514. The one-joint V-shaped link structures by the link 511 and the link 512, and the link 513 and the link 514 are connected at both ends of the rotor 261b to form a pantograph type link mechanism in which the rotary joint 521 and the rotary joint 522 expand and contract.

FIG. 5B illustrates a state in which the first output capstan 261 (shaft portion 261a) and the second output capstan 262 rotate about the roll axis and the links 511 to 514 operates in conjunction therewith. (1) of FIG. 5B in an uppermost stage illustrates a state in which a rotation angle of the first output capstan 261 (shaft portion 261a) and the second output capstan 262 about the roll axis is 0 degrees. Here, the first output capstan 261 rotates counterclockwise on the paper surface about the roll axis by the traction force of the first cable loop 241 and the second output capstan 262 rotates clockwise on the paper surface about the roll axis by the traction force of the second cable loop 242, and then as illustrated in (2) of FIG. 5B, the opening of the letter V formed by the link 511 and the link 512 is opened and the opening of the letter V formed by the link 513 and the link 514 is also opened, and the rotary joint 521 and the rotary joint 522, which are the connection portions of the respective one-link joint structures, approach each other in the roll axis direction. As a result, a distance between the lower end of the first gripper 211 and a lower end of the second gripper 212 is shortened, and the operation of closing the handle portion 201 can be realized.

On the other hand, the first output capstan 261 rotates in the clockwise direction on the paper surface about the roll axis by the traction force in the direction opposite to the above of the first cable loop 241 and the second output capstan 262 rotates in the counterclockwise direction on the paper surface about the roll axis by the traction force in the direction opposite to the above of the second cable loop 242, and then as illustrated in (3) of FIG. 5B, the opening of the letter V formed between the link 511 and the link 512 is closed and the opening of the letter V formed between the link 513 and the link 514 is also closed, and the rotary joint 521 and the rotary joint 522, which are the connection portions of the respective one-link joint structures, are both separated away in the roll axis direction. As a result, a distance between the lower end of the first gripper 211 and the lower end of the second gripper 212 increases, and the operation of opening the handle portion 201 can be realized.

On the other hand, the first output capstan 261 rotates counterclockwise on the paper surface about the roll axis by the tractive force of the first cable loop 241, and at the same time, the second output capstan 262 rotates counterclockwise on the paper surface about the roll axis by the tractive force of the second cable loop 242, and then the handle portion 201 also rotates counterclockwise on the paper surface about the roll axis while maintaining the open/close angle. In addition, the first output capstan 261 rotates in the clockwise direction on the paper surface about the roll axis by the traction force of the first cable loop 241, and at the same time, the second output capstan 262 rotates in the counterclockwise direction on the paper surface about the roll axis by the traction force of the second cable loop 242, and then the handle portion 201 also rotates in the clockwise direction on the paper surface about the roll axis while maintaining the open/close angle. In short, the first output capstan 261 and the second output capstan 261 rotate in the same direction about the roll axis, and then the handle portion 201 rotates about the roll axis without performing the opening/closing operation.

Note that in the cable layout of the first cable loop 241 and the second cable loop 242 illustrated in FIG. 2 and the like, the first input capstan 251 and the second input capstan 252 are rotated in the same direction (in other words, the first motor 231 and the second motor 232 rotate in the same direction), and then the first cable loop 241 and the second cable loop 242 are operated to rotate the first output capstan 261 and the second output capstan 262 in opposite directions about the roll axis. On the other hand, the first input capstan 251 and the second input capstan 252 are rotated in opposite directions (in other words, the first motor 231 and the second motor 232 rotate in opposite directions), and then the first cable loop 241 and the second cable loop 242 respectively operate to rotate the first output capstan 261 and the second output capstan 262 in the same direction about the roll axis.

In addition, the link mechanism that associates the first gripper 211 and the second gripper 212 as illustrated in FIG. 5 is an example, and the present invention is not limited thereto. If the first gripper 211 and the second gripper 212 can be associated with each other so as to perform an opening/closing operation with an opening width corresponding to a difference between the rotation angle of the first gripper 211 and the rotation angle of the second gripper 212 around the roll axis, a link mechanism having a configuration other than that illustrated in FIG. 5 may be used.

### C-3. Structure of Drive Unit

Next, the structure of the drive unit 203 will be described in detail.

FIG. 2 illustrates a state in which each of the motors 231 to 233 is mounted on the base 202b at the root of the shaft 202, and FIG. 6 illustrates a state in which each of the motors 231 to 233 is removed from the base 202b.

Referring to FIGS. 2 and 6, the third motor 233 is fixed to the base 202b. Furthermore, as can be seen from FIG. 6, the first slider 601 and the second slider 602 that slide in the longitudinal axis direction (or yaw axis direction) of the shaft 202 are attached to the upper surface and the lower surface of the base 202b, respectively. Then, as can be seen from FIG. 2, the first motor 231 is mounted on the first slider 601, and the second motor 232 is mounted on the second slider 601. Therefore, the first motor 231 and the second motor-232 move forward and backward in the longitudinal axis direction (or yaw axis direction) along with the sliding operation of the first slider 601 and the second slider 602, respectively.

As already mentioned, the output shaft of the first motor 231 is fitted with the first input capstan 251 winding the first cable loop 241 and the output shaft of the second motor 232 is fitted with the second input capstan 252 winding the second cable loop 242. In addition, the first cable loop 241 is wound around the first output capstan 261 on the distal end side through the shaft 202, and the second cable loop 242 is wound around the second output capstan 262 on the distal end side through the shaft 202.

For example, as can be seen from FIGS. 2 and 7, in the roll axis direction, the position in the pitch direction at which the first output capstan 261 winds the first cable loop 241 and the position in the pitch direction at which the second output capstan 262 winds the second cable loop 242 are different. That is, the first cable loop 241 passes below the pitch axis and wraps around the first output capstan 261, and the second cable loop 242 passes above the pitch axis and wraps around the second output capstan 262.

Therefore, both the outward path and the return path of the first cable loop 241 are pulled toward the root (or proximal end) side, and then a torque for rotating the wrist element 204 and the handle portion 201 counterclockwise on the paper about the pitch axis is generated. In addition, both the outward path and the return path of the second cable loop 242 are pulled toward the root (or proximal end) side, and then a torque for rotating the wrist element 204 and the handle portion 201 around the pitch axis in the clockwise direction on the paper surface is generated. However, the paper surface here refers to FIG. 2.

Therefore, the first slider 601 on which the first motor 231 is mounted is retracted and the second slider 602 on which the second motor 232 is mounted is forwarded, and then both the outward path and the return path of the first cable loop 241 are pulled toward the root (or proximal end) side, and the wrist element 204 and the handle portion 201 can be rotated counterclockwise on the paper about the pitch axis. Conversely, the second slider 602 is retracted and the first slider 601 is forwarded, and then both the outward path and the return path of the second cable loop 242 are pulled toward the root (or proximal end) side, and the st element 204 and the handle portion 201 can be rotated clockwise on the paper surface about the pitch axis. However, it is assumed that both the first cable loop 241 and the second cable loop 242 have a constant overall length.

As already mentioned, the output shaft of the third motor 233 is fitted with a third input capstan 253 around which the third cable 243 is wound. Then, as can be seen from FIGS. 2 and 6, one end of the third cable 243 is coupled to the first slider 601 through an idler pulley G1. Furthermore, the other end of the third cable 243 is coupled to the second slider 602 through an idler pulley G2. In addition, a spring 611 that applies pre-tension is inserted into the other end side of the third cable 243. However, the third cable 243 is desirably redirected by the idler pulleys G1 and G2 so as to be wound from the third input capstan 253 and laid out parallel to the longitudinal axis of the shaft 202 (alternatively, the yaw axis).

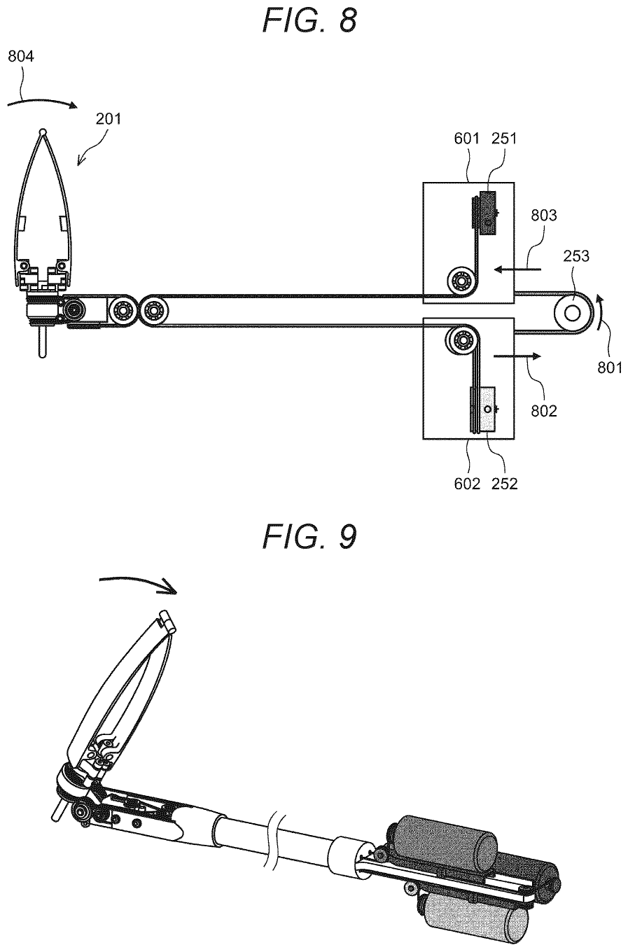

FIG. 8 illustrates a principle of rotating the handle portion 201 about the pitch axis using the third motor 233 (in FIG. 8, the motor and the idler pulley for direction conversion are not illustrated, and an input capstan connected to an output shaft of each motor and a cable layout are drawn in an abstract manner). The third input capstan 253 is rotated (in other words, the third motor 233 is rotated), and then the first slider 601 and the second slider 602 can be alternately moved forward and backward in the longitudinal axis direction (or the yaw axis direction) according to the rotation direction, and as a result, one of the first cable loop 241 and the second cable loop 242 is alternately pulled, so that the handle portion 201 can be rotated up and down about the pitch axis.

For convenience of description, in FIG. 8, the rotation axis (alternatively, the output shaft of the third motor 233) of the third input capstan 253 is drawn in a direction orthogonal to the paper surface or in a direction parallel to the pitch axis. In FIG. 8, rotating the third input capstan 253 in the counterclockwise direction can retract the second slider 602 toward the root side to pull the second cable loop 242, so that the first slider 601 is forwarded toward the distal end side and the handle portion 201 rotates upward about the pitch axis. The movements of the second input capstan 253, the first slider 601, the second slider, and the handle portion 201 in this case are indicated by arrows 801 to 804 in FIG. 8. Conversely, rotating the third input capstan 253 in the counterclockwise direction may cause the first slider 601 to retract proximally to pull the first cable loop 241, resulting in the second slider 602 advancing distally and the handle portion 201 rotating downwardly about the pitch axis. The movements of the second input capstan 253, the first slider 601, the second slider, and the handle portion 201 in this case are in directions opposite to the arrows 801 to 804.

FIGS. 9 to 11 illustrate a state in which the handle portion 201 is rotated about the pitch axis by driving the third input capstan 253 (alternatively, the third motor 233). As can be seen from FIGS. 9 to 11, the third input capstan 253 is driven, so that the first slider 601 on which the first motor 231 is mounted and the second slider 602 on which the second motor 232 is mounted are moved forward and backward in the longitudinal axis direction of the shaft 202.

The rotational drive of the third input capstan 253 pulls the second slider 602 by the third cable 243 and retracts the second slider 602 to the proximal end side in the longitudinal axis direction of the shaft 202. Then, the handle portion 201 is pulled by the second cable loop 242 and rotates upward about the pitch axis as illustrated in FIG. 9.

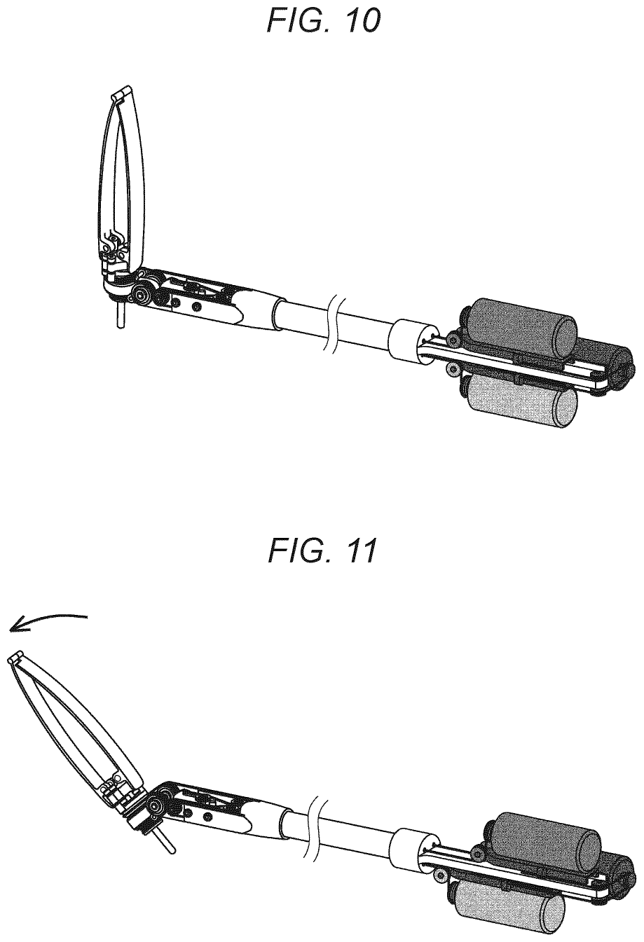

In addition, in a case where the positions of the first slider 601 and the second slider 602 in the longitudinal axis direction of the shaft 202 are the same, as illustrated in FIG. 10, the rotational position of the handle portion 201 around the pitch axis is 0 degrees.

In addition, the first slider 601 is pulled by the third cable 243 and retracted to the proximal end side in the longitudinal axis direction of the shaft 202 by the reverse rotational drive of the third input capstan 253. Then, the handle portion 201 is pulled by the first cable loop 241 and rotates downward about the pitch axis as illustrated in FIG. 11.

In this manner, the third cable 243 is pulled with the third input capstan 253 and one of the first cable loop 241 and the second cable loop 242 is selectively pulled in accordance with the forwarding and retracting operations of the first slider 601 and the second slider 602, so that the handle portion 201 can be rotated about the pitch axis. Further, when the handle portion 201 is rotated about the pitch axis, the pre-tension of the first cable loop 241 and the second cable loop 242 does not change.

As described above, the operation input device 200 according to the present embodiment includes the handle portion 201 operated by the operator, the drive unit 203 that drives the handle portion 201, and the shaft 202 that connects the handle portion 201 and the drive unit 203 (through which a cable for transmission is inserted), and can perform a rotation operation around a roll axis, an opening/closing operation, and a rotation operation around a pitch axis of the handle portion 201. Methods for realizing these three operations are summarized below.

### <<Rotation Operation of Handle 201 Around Roll Axis>>

(1) The first motor 231 and the second motor 232 are driven in opposite directions to rotate the first input capstan 251 and the second input capstan 252 in opposite directions.

(2) The first cable loop 241 and the second cable loop 242 are activated to rotate the first output capstan 261 and the second output capstan 262 in the same direction.

(3) As a result, the first gripper 211 and the second gripper 212 simultaneously rotate in the same direction, and the rotation of the handle portion 201 about the roll axis is realized.

### <<Opening/Closing Operation of Handle Portion 201>>

(1) The first motor 231 and the second motor 232 are driven in the same direction to rotate the first input capstan 251 and the second input capstan 252 in the same direction.

(2) The first cable loop 241 and the second cable loop 242 are activated to rotate the first output capstan 261 and the second output capstan 262 in opposite directions.

(3) As a result, the angle of the V shape formed by the link 511 and the link 512 and the angle of the V shape formed by the link 513 and the link 514 change.
(4) As a result, the first gripper 211 and the second gripper 212 perform opening and closing operations. When the above V-shaped opening is closed, the first gripper 211 and the second gripper 212 are opened, and when the V-shaped opening is opened, the first gripper 211 and the second gripper 212 are closed.

### <<Rotation Operation of Handle Portion 201 Around Pitch Axis>>

(1) The third motor 233 is driven to rotate the third input capstan 253.

(2) The first slider 601 and the second slider 602 are alternately moved forward and backward according to the rotation direction of the third input capstan 253.

(3) As a result, one of the first cable loop 241 and the second cable loop 242 is selectively pulled, so that the handle portion 201 rotates up and down about the pitch axis.

### C-4. Input/Output Relationship Between Drive Unit and Handle Portion

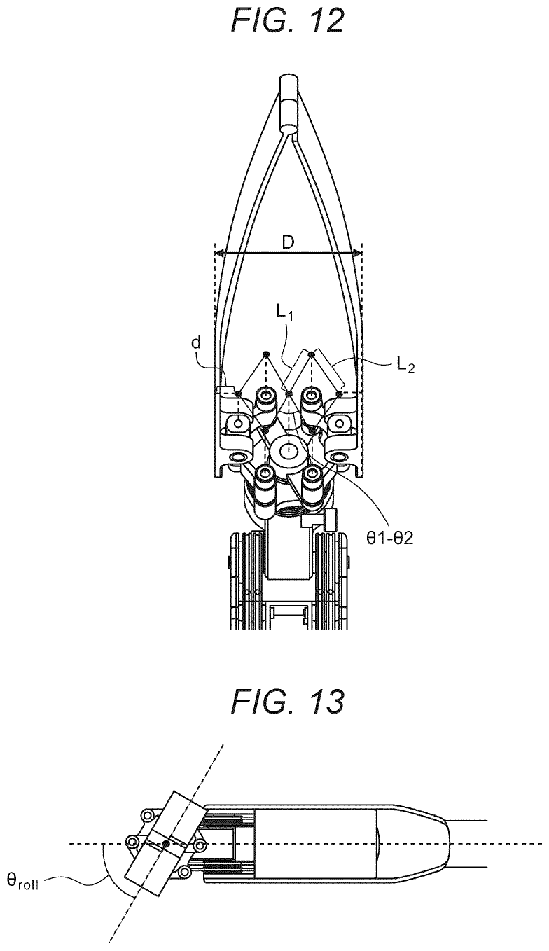

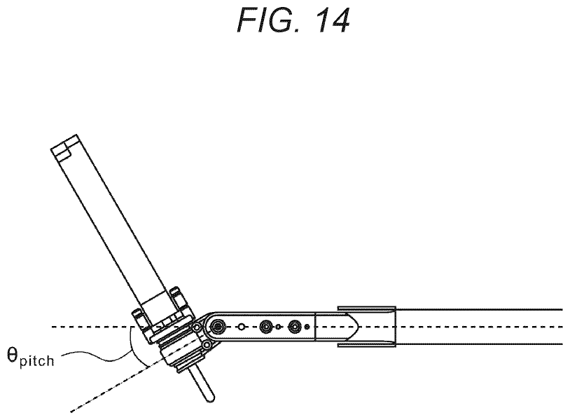

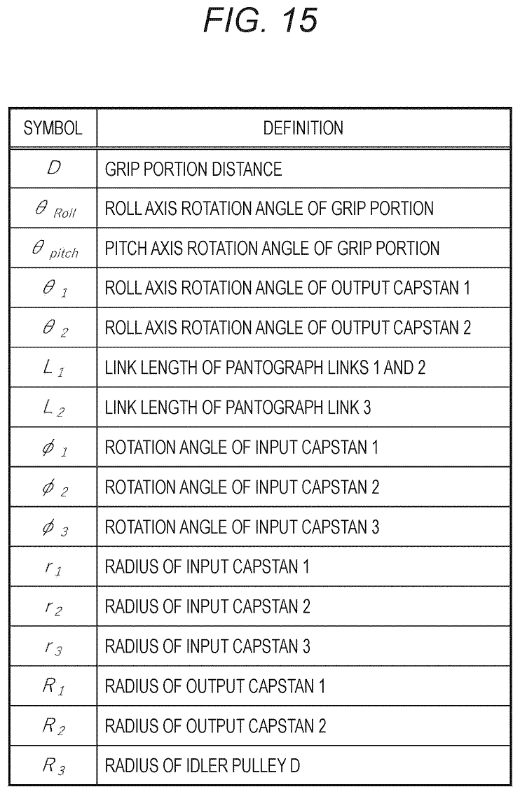

Next, an input/output relationship in the operation input device 200 will be described. However, the input to the operation input device 200 is driving of the first to third motors 231 to 233, and specifically, rotation angles φ₁, φ₂, and φ₃ of the first input capstan 251, the second input capstan 252, and the third input capstan 253 are input. Further, the output from the operation input device 200 is the operation of the handle portion 201 with respect to the drive of the first to third motors 231 to 233, and specifically, a rotation angle θᵣₒₗₗ of the handle portion 201 around the roll axis, a rotation angle θ_{pitch} around the pitch axis, and the distance D between the first gripper 211 and the second gripper 212 are set as the outputs. FIGS. 12 to 14 illustrate variables used in the input/output relationship in the operation input device 200 in a perspective view, a top view, and a side view of the handle portion 201. Furthermore, FIG. 15 summarizes definitions of constants and variables used in the input/output relationship in the operation input device 200. Note that, although not illustrated in FIG. 15, a constant d in FIG. 12 is a distance (and a distance between a root portion of the second gripper 212 and an opening/closing shaft of a V shape formed by the link 513 and the link 514) between the root of the first gripper 211 and the opening/closing shaft of the V shape formed by the link 511 and the link 512. If the opening and closing axis is designed to coincide with the root of the first gripper 211, d=0.

A rotation angle θ₁ at which the first output capstan 261 rotates about the roll axis from a reference posture with respect to the rotation angle φ₁ of the first input capstan 251 and a rotation angle θ₂ at which the second output capstan 262 rotates about the roll axis from the reference posture with respect to the rotation angle φ₂ of the second input capstan 251 are as in the following Expressions (1) and (2), respectively.

$$[ Expression 1 ]$$

$${θ}_{1} = \frac{{r}_{1}}{{R}_{1}} {ϕ}_{1} \qquad ( 1 )$$

$$[ Expression 2 ]$$

$${θ}_{2} = \frac{{r}_{2}}{{R}_{2}} {ϕ}_{2} \qquad ( 2 )$$

Then, the rotation angle θᵣₒₗₗ about the roll axis and the rotation angle θ_{pitch} about the pitch axis of the handle portion 201 with respect to the rotation angles θ₁ and θ₂ from the basic posture about the roll axis of each of the first output capstan 261 and the second output capstan 262 are as in the following Expressions (3) and (4), respectively.

$$[ Expression 3 ]$$

$${θ}_{Roll} = \frac{{θ}_{1} + {θ}_{2}}{2} \qquad ( 3 )$$

$$[ Expression 4 ]$$

$${θ}_{Pitch} = \frac{2 {r}_{3}}{{R}_{3}} {ϕ}_{3} \qquad ( 4 )$$

In addition, the distance (that is, the opening width of the handle portion 201) D between the first gripper 211 and the second gripper 212 with respect to the rotation angles θ₁ and θ₂ about the roll axes of the first output capstan 261 and the second output capstan 262 is as in the following Expression (5).

$$[ Expression 5 ]$$

$$D = 2 d + 2 ( {L}_{1} + {L}_{2} ) sin ( \frac{{θ}_{1} - {θ}_{2}}{2} ) \qquad ( 5 )$$

As can be seen from the above Expressions (1) to (3), the first input capstan 251 and the second input capstan 252 rotate in opposite directions, and then the first output capstan 261 and the second output capstan 262 rotate in the same direction about the roll axis, and an average of the rotation angles θ₁ and θ₂ from the respective basic postures is the rotation angle about the roll axis of the handle portion 201. It can be said that the handle portion 201 rotates about the roll axis at a rotation angle proportional to the average of the rotation angles θ₁ and θ₂ about the roll axis of each of the first output capstan 261 and the second output capstan 262.

In addition, as can be seen from the above Expression (5), the first input capstan 251 and the second input capstan 252 rotate in the same direction, and then the rotation of the first output capstan 261 and the second output capstan 262 around the roll axis in opposite directions is canceled. Therefore, the handle portion 201 does not rotate around the roll axis, but the first gripper 211 and the second gripper 212 perform opening and closing operations. It can be said that the first gripper 211 and the second gripper 212 perform the opening/closing operation with the opening width D according to the difference between the rotation angles θ₁ and θ₂ about the roll axes of the first output capstan 261 and the second output capstan 262.

Also, as can be seen from the above Expression (4), the handle portion 201 rotates about the pitch axis in proportion to the rotation angle φ₃ of the third input capstan 253. From the configuration in which the first cable loop 241 and the second cable loop 242 are respectively wound around the first output capstan 261 and the second output capstan 262 at different positions sandwiching the pitch axis in the roll axis direction, a rotational operation about the pitch axis of the handle portion 201 is generated by driving the third motor 233 to alternately forward and retreat the first motor 231 and the second motor 232 in the yaw axis direction.

The respective rotation angles φ₁, φ₂, φ₃ of the first input capstan 251, the second input capstan 252, and the third input capstan 253 can be respectively measured by encoders provided on the respective output shafts of the first motor 231, the second motor 232, and the third motor 233.

In a case where the operator performs a rotation operation or a gripping operation on the handle portion 201 of the operation input device 200 for the remote operation of the surgical manipulator 122, the rotation angle θᵣₒₗₗ about the roll axis, the rotation angle θ_{pitch} about the pitch axis, and the gripping operation amount D of the handle portion 201 can be calculated on the basis of the rotation angles φ₁, φ₂, and φ₃ measured by the encoders. Then, the master-side control unit 111 can generate a command for remotely operating the surgical manipulator 122 on the basis of the converted rotation angles θᵣₒₗₗ and θ_{pitch} and the gripping operation amount D and transmit the command to the slave device 120.

In addition, in a case where the external force received by the surgical manipulator 122 is haptically presented to the operator, the master-side control unit 111 may calculate the rotation angle θᵣₒₗₗ of the handle portion 201, the rotation angle θ_{pitch} around the pitch axis, and the gripping operation amount D on the basis of the haptic information received from the slave device 120, and may perform the drive control of the first to third motors 231 to 233 by calculating back the respective rotation angles φ₁, φ₂, and φ₃ of the first input capstan 251, the second input capstan 252, and the third input capstan 253 for realizing these outputs.

### C-5. Operation of Handle Portion

In the above paragraph C-4, the handle portion 201 can realize the rotation operation about the roll axis, the rotation operation about the pitch axis, and the opening and closing operation of the first gripper 211 and the second gripper 212 according to the rotation angles φ₁, φ₂, and φ₃ of the first input capstan 251, the second input capstan 252, and the third input capstan 253.

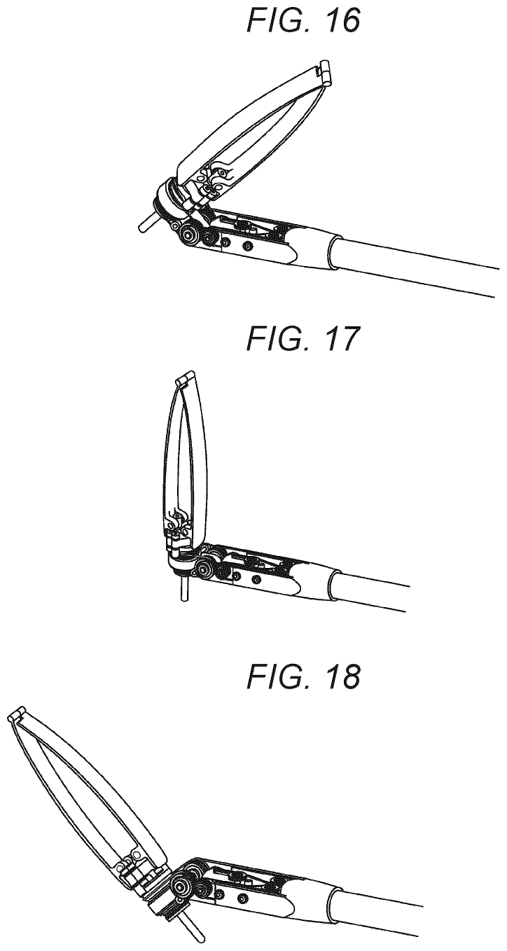

FIGS. 16 to 18 illustrate how the handle portion 201 rotates about the pitch axis with respect to the shaft 202. However, in FIGS. 16 to 18, the rotation angle of the handle portion 201 around the roll axis is set to 0 degrees, and the posture of the shaft 202 and the gripping operation amount of the first gripper 211 and the second gripper 212 are fixed. FIG. 16 illustrates a state in which the handle portion 201 rotates in the negative direction around the pitch axis, FIG. 17 illustrates a state in which the rotation angle of the handle portion 201 around the pitch axis is 0 degrees, and FIG. 18 illustrates a state in which the handle portion 201 rotates in the positive direction around the pitch axis.

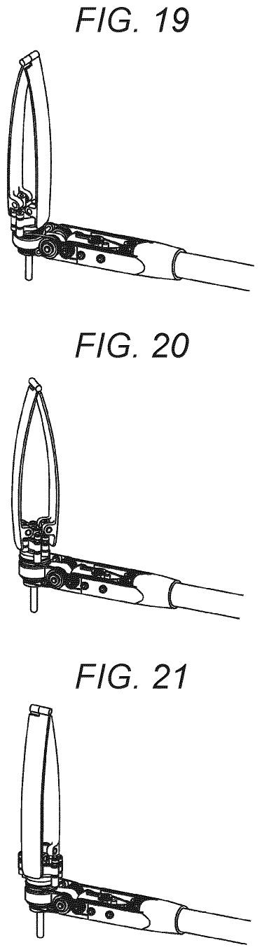

Furthermore, FIGS. 19 to 21 illustrate a state in which the handle portion 201 rotates about the roll axis with respect to the shaft 202. However, in FIGS. 19 to 21, the rotation angle of the handle portion 201 around the pitch axis is set to 0 degrees, and the posture of the shaft 202 and the gripping operation amount of the first gripper 211 and the second gripper 212 are fixed. FIG. 19 illustrates a state in which the rotation angle of the handle portion 201 around the roll axis is 0 degrees, FIG. 20 illustrates a state in which the handle portion 201 rotates 45 degrees around the roll axis, and FIG. 21 illustrates a state in which the handle portion 201 rotates 90 degrees around the roll axis.

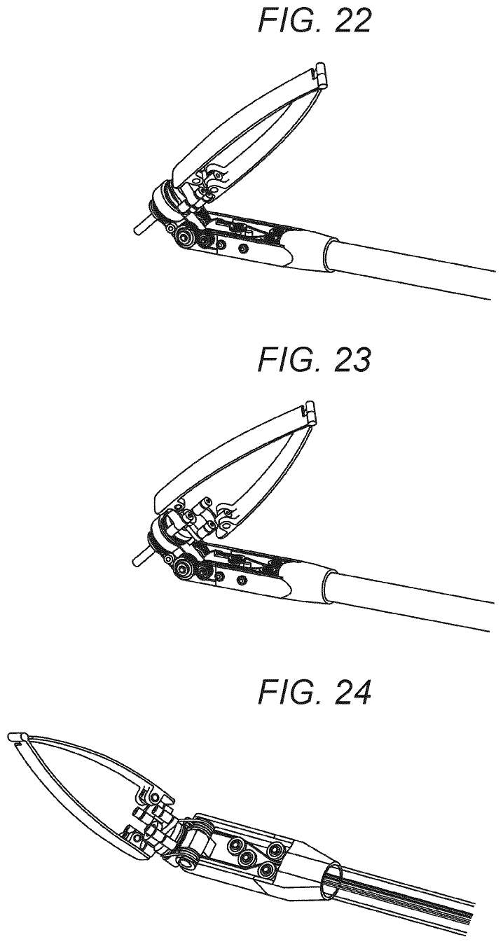

Also, FIGS. 22 and 23 illustrate a state in which the first gripper 211 and the second gripper 212 of the handle portion 201 perform an opening/closing operation. However, in FIGS. 22 and 23, the rotation angles around the roll axis and the pitch axis of the handle portion 201 are both set to 0 degrees and the posture of the shaft 202 is fixed, FIG. 22 illustrates a state in which the first gripper 211 and the second gripper 212 are closed (or D is minimum), and FIG. 23 illustrates a state in which the first gripper 211 and the second gripper 212 are opened (or D is at most).

In the above description, the rotational operation of the handle portion 201 around the yaw axis has not been mentioned. The yaw axis is the longitudinal axis of the shaft 202, and the rotational operation of the handle portion 201 around the yaw axis can be realized by rotating the entire operation input device 200 illustrated in FIG. 2 around the longitudinal axis of the shaft 202.

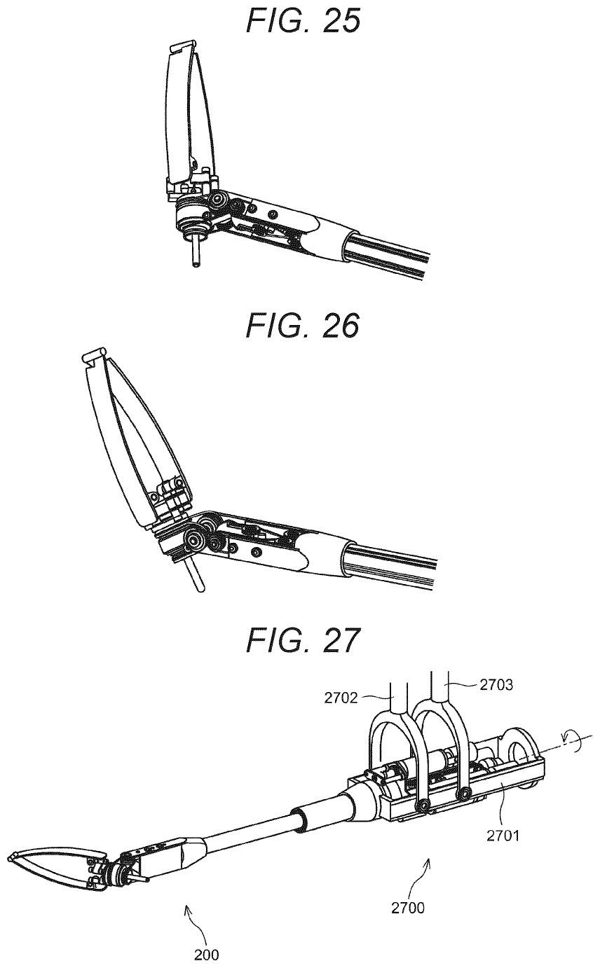

FIGS. 24 to 26 illustrate how the handle portion 201 rotates about the yaw axis. However, in FIGS. 24 to 26, the rotation angles around the roll axis and the pitch axis of the handle portion 201 are both set to 0 degrees, and the posture of the shaft 202 is fixed, and FIG. 24 illustrates a state in which the handle portion 201 rotates in the negative direction around the yaw axis, FIG. 25 illustrates a state in which the rotation angle around the yaw axis of the handle portion 201 is 0 degrees, and FIG. 26 illustrates a state in which the handle portion 201 rotates in the positive direction around the yaw axis. As described in the preceding paragraph, the yaw axis rotation is realized by rotating the entire operation input device 200 around the longitudinal axis of the shaft 202, but for simplification of the drawings, only the vicinity of the handle portion 201 at the distal end is illustrated in FIGS. 24 to 26.

The operation input device 200 according to the present embodiment has a rotational degree of freedom about three axes of the roll axis, the pitch axis, and the yaw axis of the handle portion 201, and a total of four degrees of freedom of the gripping operation. However, as illustrated in FIGS. 16 to 26, the rotational three-axis operation can be concentrated near the handle portion 201. In addition, the operation input device 200 according to the present embodiment has a configuration in which the drive unit 203 including each of the motors 231 to 233 is arranged on the root side of the shaft 202, and the three rotation axes of the handle portion 201 are driven by the transmission mechanism using the cable loops 241 to 243. As compared with the configuration in which the motor is disposed for each joint, the mechanism of the handle portion 201 at the distal end is simple and small. Therefore, the operation input device 200 according to the present embodiment has the following advantages (1) to (3) as described in above Section B above.
(1) Operation with both hands close to each other is possible
(2) Hand rest (or wrist rest) is arrangeable
(3) The arm distal end portion is reduced in weight.

### C-6. Yaw Axis Operation of Handle Portion

In item C-6, a specific configuration example for realizing the rotational operation of the handle portion 201 about the yaw axis will be described.

FIGS. 27 to 29 illustrate a state in which a device holder 2700 holds the operation input device 200 near the drive unit 203 and rotates the entire operation input device 200 about the yaw axis.

The device holder 2700 includes a drive mechanism unit 2701 and two tilt links 2702 and 2703 that support the drive mechanism unit 2701 at two locations. The drive mechanism unit 2701 rotatably supports the operation input device 200 around a yaw axis (alternatively, the longitudinal axis of the shaft 202) in the vicinity of the drive unit 203. Then, the drive mechanism unit 2701 can rotate the operation input device 200 about the yaw axis by using a spur gear, a cable deceleration structure, or the like. In addition, although the two tilt links 2702 and 2703 support the drive mechanism unit 2701 at two locations, it is possible to tilt the operation input device 200 mounted on the device holder 2700 with respect to the horizontal by raising one of the two tilt links higher than the other or lowering one of the two tilt links lower than the other.

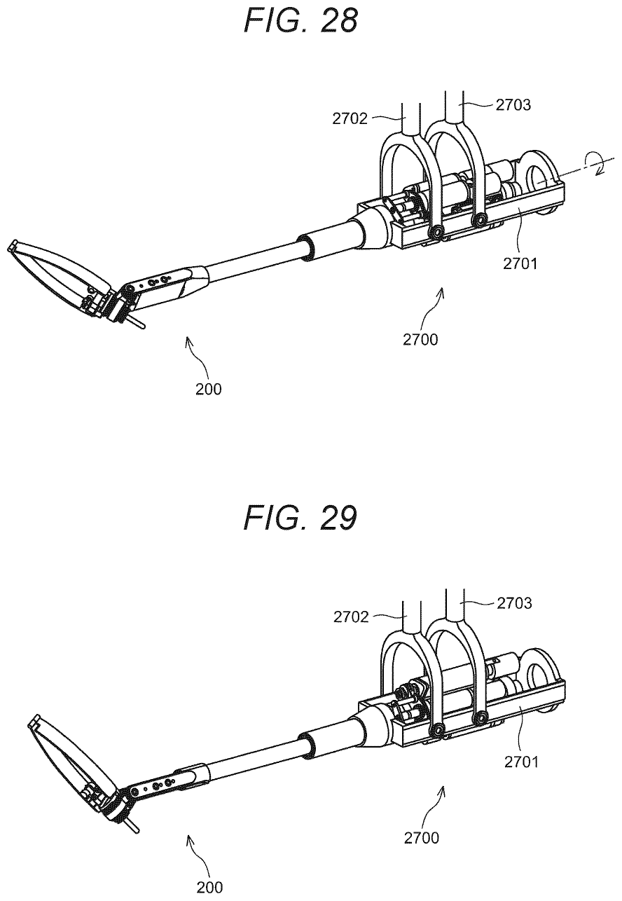

In FIGS. 27 to 29, FIG. 27 illustrates a state in which the entire operation input device 200 rotates in a negative direction about the yaw axis, FIG. 28 illustrates a state in which the entire operation input device 200 rotates in a positive direction about the yaw axis from the state illustrated in FIG. 27, and FIG. 29 illustrates a state in which the rotation angle of the entire operation input device 200 about the yaw axis is 0 degrees, while the posture of the shaft 202 (inclination in the longitudinal axis direction or the pitch axis) is fixed while the rotation angle of the handle portion 201 about the roll axis is 0 degree.

### D. MODIFICATION

### D-1. Structure in which Roll Axis and Pitch Axis Intersect

In the case of the operation input device 200 described in the above item C, the roll axis and the pitch axis of the handle portion 201 do not intersect with each other and are disposed apart from each other. Specifically, as can be seen from FIGS. 2 to 4, the wrist element 204 pivotable about the pitch axis is attached to the socket 202a at the distal end of the shaft 202, and the wrist element 204 rotatably supports the handle portion 201 about the roll axis. In the configuration example illustrated in FIGS. 2 to 4, the roll axis and the pitch axis of the handle portion 201 do not intersect and are offset.

On the other hand, in item D-1, a structure in which the roll axis and the pitch axis of the handle portion 201 intersect will be described. By adopting a structure in which the roll axis and the pitch axis intersect, similarly to the gimbal structure (see, for example, Patent Document 1), the handle portion 201 can be pivoted with the intersection of the roll axis and the pitch axis as a fulcrum, and there is an advantage that control becomes easy. Incidentally, in a case where the roll axis and the pitch axis of the handle portion 201 are arranged apart from each other without intersecting each other as described in the above item C, even if the wrist element 204 is rotated about the pitch axis, the handle portion 201 and the mechanism at a preceding stage of the pitch axis do not interfere with each other, and thus there is an advantage that the rotation movable range of the handle portion 201 about the pitch axis can be widened.

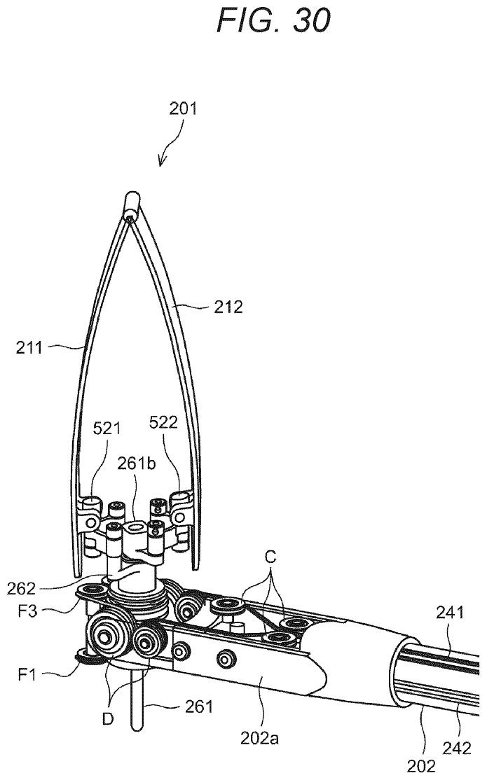

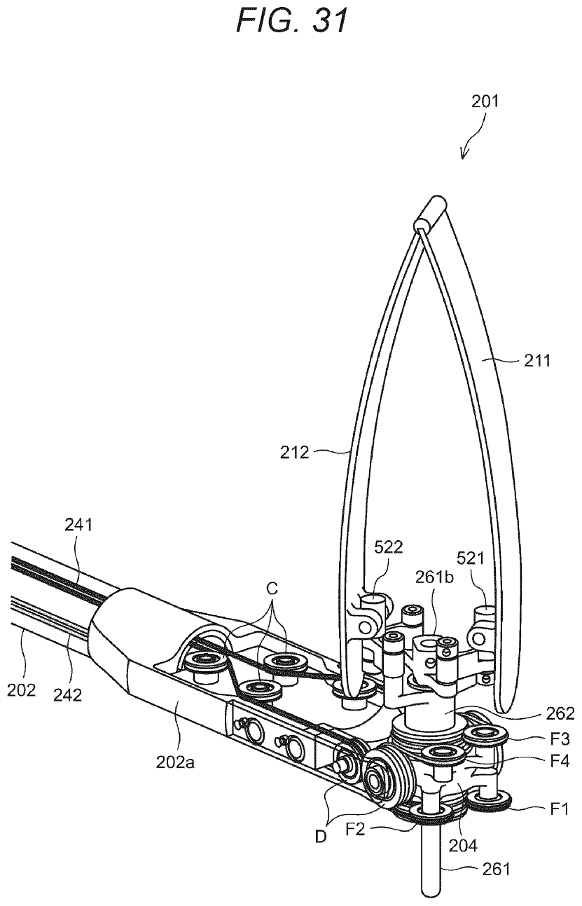

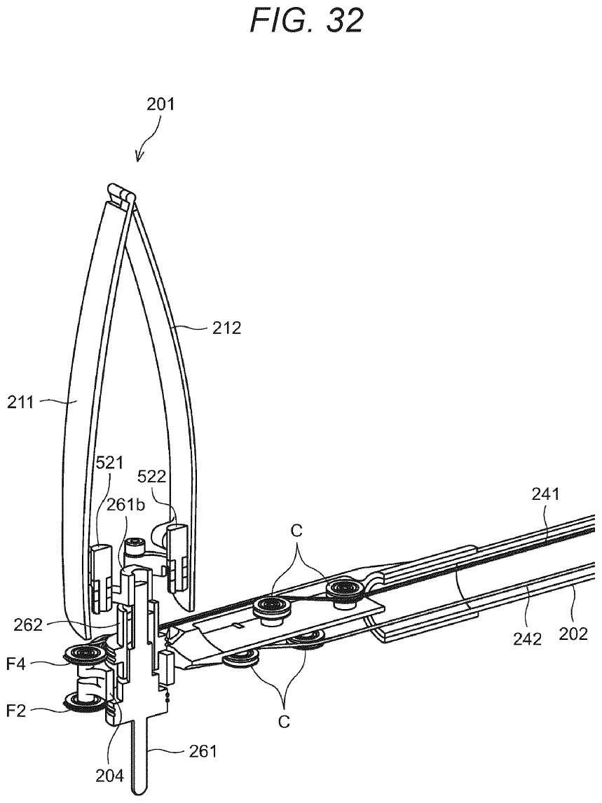

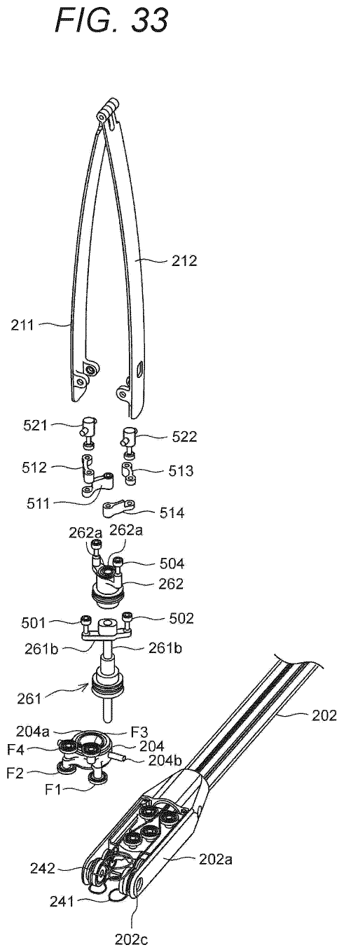

In FIGS. 30 and 31, the structure near the handle portion 201 configured such that the roll axis and the pitch axis intersect is illustrated in an enlarged manner. However, FIG. 30 is a perspective view of the vicinity of the handle portion 201 from the root side, and FIG. 31 is a perspective view of the vicinity of the handle portion 201 from the distal end side. Furthermore, FIG. 32 is a cross-sectional view of the vicinity of the distal end of the shaft 202, and FIG. 33 is an exploded view of the handle portion 201.

Also in this modification, both the idler pulley group C and the idler pulley group D are rotatably connected to the socket 202a, the idler pulley group C plays a role of winding the first cable loop 241 and the second cable loop 242 from the inside of the shaft 202, and the idler pulley group D plays a role of redirecting the first cable loop 241 and the second cable loop 242 wound by the idler pulley group C and winding those loops around the first output capstan 261 and the second output capstan 262.

Furthermore, the pair of idler pulleys at the extreme distal end (distal end side) of the idler pulley group D rotates about the pitch axis. Since the roll axis and the pitch axis intersect, the idler pulley at the most distal end (distal end side) of the idler pulley group D is arranged such that the rotation axis intersects the roll axis.

As can be seen from FIG. 33, the wrist element 204 pivotable about the pitch axis is attached to the socket 202a at the tip end (or the distal end) of the shaft 202. Then, the wrist element 204 rotatably supports the handle portion 201 about the roll axis. Therefore, the handle portion 201 has rotational degrees of freedom about two axes of the pitch axis and the roll axis with respect to the shaft 202.

Here, as can be seen from FIGS. 31 and 32, idler pulleys F1 and F2 are disposed on the outward path and the return path of the first cable loop 241, respectively. The idler pulley F1 moves the path of the first cable loop 241 wound from the idler pulley at the most distal end (on the distal end side) of the idler pulley group D in the roll axis direction and winds the first cable loop 241 around the first output capstan 261 so as not to overlap with the return path, and the idler pulley F2 converts the direction of the first cable loop 241 wound from the first output capstan 261 and winds the first cable loop 241 around the idler pulley group D. As a result, the outward path and the return path of the first cable loop 241 can be overlapped around the roll axis and simultaneously wound around the first output capstan 261, and the rotation movable range of the first output capstan 261 around the roll axis can be maximized. The idler pulleys F1 and F2 are connected to the wrist element 204.

Similarly, idler pulleys F3 and F4 are disposed on the outward path and the return path of the second cable loop 242, respectively. The idler pulley F3 moves the course of the second cable loop 242 wound from the idler pulley at the most distal end (on the distal end side) of the idler pulley group D in the roll axis direction and winds the second cable loop 242 around the second output capstan 262 so as not to overlap with the return path, and the idler pulley F4 converts the direction of the second cable loop 242 wound from the second output capstan 262 and winds the second cable loop 242 around the idler pulley group D. As a result, the outward path and the return path of the second cable loop 242 can be overlapped around the roll axis and simultaneously wound around the second output capstan 262, and the rotation movable range around the roll axis of the second output capstan 262 can be maximized. The idler pulleys F3 and F4 are connected to the wrist element 204.

Furthermore, referring to FIG. 33, the second output capstan 262 is supported by the wrist element 204 through a bearing 204a so as to be rotatable about the roll axis. The structure in which the wrist element 204 is supported by the socket 202 so as to be rotatable about the pitch axis is similar to the above (see FIG. 5A), but a pair of protrusions 204b coaxial with the pitch axis is formed so as to cross the roll axis. In addition, a circular opening centered on the roll axis is drilled in the center of the second output capstan 262. The first output capstan 261 is supported in a central opening of the second output capstan 262 through a bearing 262a so as to be rotatable about the roll axis. Thus, the first output capstan 261 and the second output capstan 262 are supported so as to be rotatable about the roll axis independently of one another.

Further, referring to FIG. 33, the first output capstan 261 is provided with a shaft portion 261a protruding in the roll axis direction at the center. The shaft portion 261a emerges from the central opening of the second output capstan 262, and a rotor 261b linear in the diametrical direction is attached to the distal end thereof. The first output capstan 261 rotates by the rotational force transmitted by the first cable loop 241, and then the rotor 261b rotates integrally with the first output capstan 261 about the roll axis.

A pair of protrusions 501 and 502 aligned in the diametrical direction are provided at both ends of the rotor 261b. In addition, a pair of protrusions 503 and 504 arranged in another diametrical direction is also formed on the upper surface of the second output capstan 262. One end of a link 511 is rotatably attached to the projection 501, one end of a link 512 is rotatably attached to the projection 503, and the other ends of the link 511 and the link 512 are rotatably connected by using a rotary joint 521. The link 511 and the link 512 are one-joint link structures having a V shape opened on the roll axis side. On the other hand, one end of a link 513 is rotatably attached to the projection 502, one end of the link 514 is rotatably attached to the projection 504, and the other ends of the link 513 and the link 514 are rotatably connected to each other by using a rotary joint 522. The link 513 and the link 514 are one-joint link structures having a V shape facing the link 511 and the link 512 and opened on the roll axis side.

The first gripper 211 and the second gripper 212 are rotatably coupled at the upper end. A lower end of the first gripper 211 is rotatably attached to an upper portion of the rotary joint 521 connecting the link 511 and the link 512. Also, a lower end of the second gripper 212 is rotatably attached to an upper portion of the rotary joint 522 that connects the link 513 and the link 514. The one-joint V-shaped link structures by the link 511 and the link 512, and the link 513 and the link 514 are connected at both ends of the rotor 261b to form a pantograph type link mechanism in which the rotary joint 521 and the rotary joint 522 expand and contract.

As described with reference to FIG. 5B, the first output capstan 261 (shaft portion 261a) and the second output capstan 262 rotate about the roll axis, and the links 511 to 514 operates in conjunction therewith. Specifically, when the first output capstan 261 is rotated in the counterclockwise direction on the paper surface by the traction force of the first cable loop 241 and the second output capstan 262 is rotated in the clockwise direction on the paper surface by the traction force of the second cable loop 242, the V-shaped opening formed by the link 511 and the link 512 is opened and the V-shaped opening formed by the link 513 and the link 514 is also opened, and both the rotary joint 521 and the rotary joint 522, which are the connection portions of the one-link joint structures, approach the roll axis. As a result, a distance between the lower end of the first gripper 211 and a lower end of the second gripper 212 is shortened, and the operation of closing the handle portion 201 can be realized.

On the other hand, when the first output capstan 261 is rotated in the clockwise direction on the paper surface by the traction force in the direction opposite to the above direction of the first cable loop 241 and the second output capstan 262 is rotated in the counterclockwise direction on the paper surface by the traction force in the direction opposite to the above direction of the second cable loop 242, the opening of the letter V formed by the link 511 and the link 512 is closed, and the opening of the letter V formed by the link 513 and the link 514 is also closed, so that both the rotary joint 521 and the rotary joint 522, which are the connection units of the respective one-link joint structures, move away from the roll axis. As a result, a distance between the lower end of the first gripper 211 and the lower end of the second gripper 212 increases, and the operation of opening the handle portion 201 can be realized.

On the other hand, the first output capstan 261 rotates counterclockwise on the paper surface by the traction force of the first cable loop 241, and at the same time, the second output capstan 262 rotates counterclockwise on the paper surface by the traction force of the second cable loop 242, and then the handle portion 201 also rotates counterclockwise on the paper surface about the roll axis. In addition, the first output capstan 261 rotates in the clockwise direction on the paper surface by the traction force of the first cable loop 241, and at the same time, the second output capstan 262 rotates in the counter direction on the paper surface by the traction force of the second cable loop 242, and then the handle portion 201 also rotates in the clockwise direction on the paper surface about the roll axis. In short, the first output capstan 261 and the second output capstan 261 rotate in the same direction about the roll axis, and then the handle portion 201 rotates about the roll axis without performing the opening/closing operation.

Note that the link mechanism that associates the first gripper 211 and the second gripper 212 as illustrated in FIG. 32 is an example, and the present invention is not limited thereto. As long as the first gripper 211 and the second gripper 212 can be associated with each other such that the first gripper 211 and the second gripper 212 have a structure in which the roll axis and the pitch axis of the handle portion 201 intersect each other and perform an opening/closing operation with an opening width corresponding to a difference between the rotation angle of the first gripper 211 and the rotation angle of the second gripper 212 around the roll axis (same as above), a link mechanism having a configuration other than that illustrated in FIG. 32 may be used.

### D-2. Backlash-Free Design

In a case where a geared motor in which a speed reducer is connected to an output shaft is used as the first motor 231 and the second motor 232 that drive the first input capstan 251 and the second input capstan 252, respectively, backlash occurs in the rotation operation and the gripping operation of the handle portion 201 about the roll axis. When there is backlash in the output shafts of the first motor 231 and the second motor 232, the backlash of a rotation angle φ₁ of the first input capstan 251 and the rotation angle φ₂ of the second input capstan 252 appears as it is. Therefore, as can be seen from the above Expressions (1) to (3) and (5), backlash occurs in the rotation operation and the gripping operation about the roll axis of the handle portion 201.

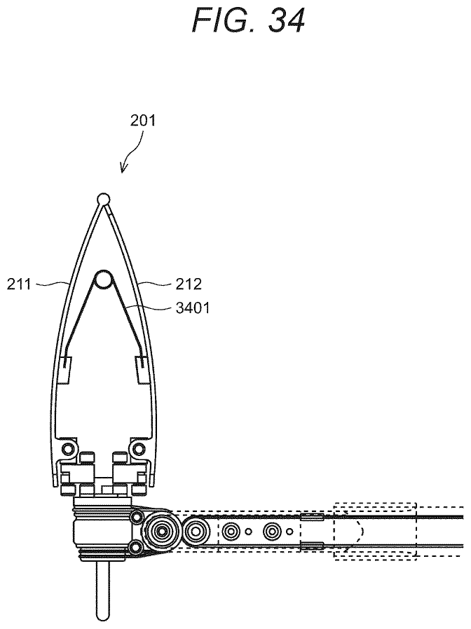

As a solution thereof, as illustrated in FIG. 34, a method of arranging a torsion spring 3401 in which a restoring force acts in a closing direction between the first gripper 211 and the second gripper 212 in the handle portion 201 is proposed. In such a case, with application of a force in a direction of always opening to the first gripper 211 and the second gripper 212 by the driving force of the first motor 231 and the second motor 232, the restoring force of the torsion spring 3401 and the driving force of each of the motors 231 and 232 are opposed to each other, and the geared motor is biased, so that it is possible to remove backlash of the rotating operation and the gripping operation about the roll axis of the handle portion 201.

Note that measures for applying the force in the closing direction between the first gripper 211 and the second gripper 212 is not limited to the torsion spring 3401. For example, a leaf spring, a tension coil spring, or the like may be disposed between the first gripper 211 and the second gripper 212. In addition, instead of connecting the first gripper 211 and the second gripper 212 by a spring, a force in a closing direction can be applied between the first gripper 211 and the second gripper 212 by inserting a coil spring structure (in a compressed state such that a restoring force acts in a direction in which the first gripper 211 or the second gripper 212 closes,) into the rotation shafts of the roots of the first gripper 211 and the second gripper 212 (the contact points of the rotary joint 521 and the rotary joint 522).

### D-3. Handle Portion Structure

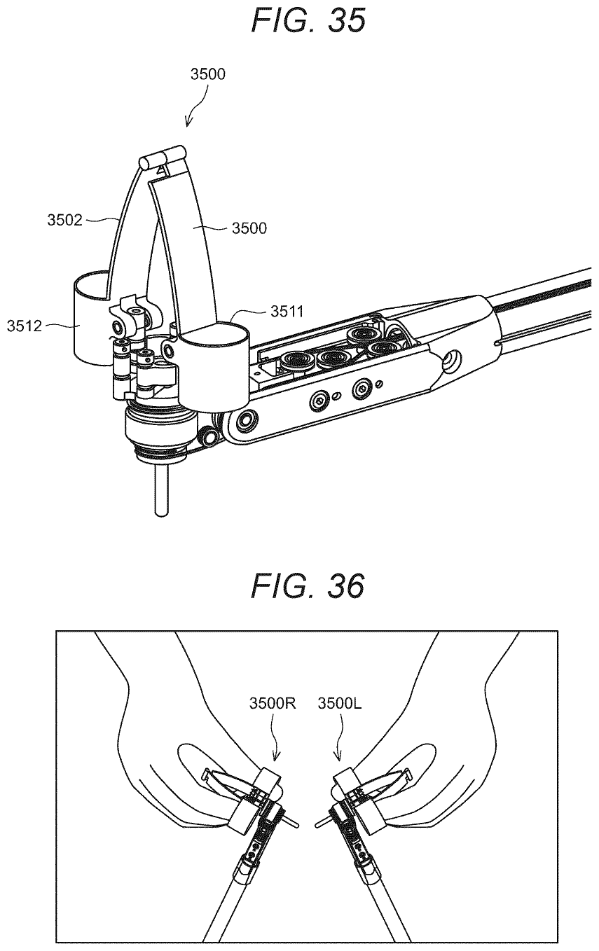

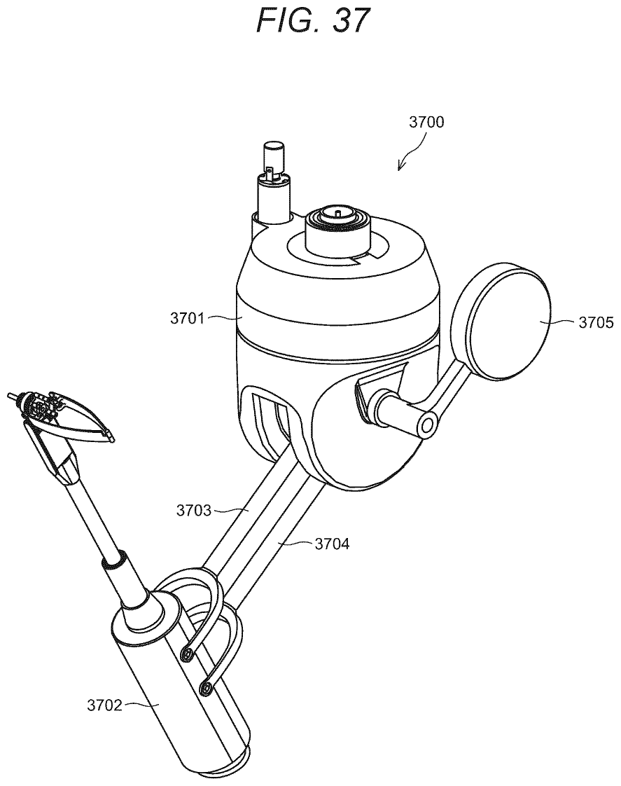

FIG. 35 illustrates a handle portion 3500 according to a modification. In addition, FIG. 36 illustrates a usage example of the handle portion 3500 illustrated in FIG. 35.

The handle portion 3500 is the same as the handle portion 201 described above in that the handle portion is configured by a pair of grippers, but the first gripper 3501 and the second gripper 3502 are both shortened in length. However, ring-shaped fingertip holding portions 3511 and 3512 are provided near the root (near the contact points with the rotary joints 521 and 522), respectively. For example, the operator can perform a gripping operation of the handle portion 3500 by inserting a thumb and an index finger into the fingertip holding portions 3511 and 3512 and opening and closing the thumb and the index finger.

FIG. 36 illustrates a state in which left and right symmetrical handle portions 3500R and 3500L having the same structure are arranged to face each other, and the operator operates each handle portion 3500 using the left and right thumbs and the index finger. The operator can insert the thumb and the index finger into the fingertip holding portions 3511 and 3512 to perform the gripping operation of the first gripper 3501 and the second gripper 3502, and rotate the handle portion 3500 about the roll axis and the pitch axis to remotely operate the surgical manipulator 122 (not illustrated in FIG. 36) on the slave side. In addition, as can be seen from FIG. 35, the mechanism in the vicinity of the handle portion 3500 is small, and in a case where the operator operates the individual handle portions 3500 with the left and right hands, the operator can operate the handle portions 3500R and 3500L of both hands by bringing the handle portions close to each other to the extent that the fingertips of both hands touch.

Note that the sizes of the rings of the fingertip holding portions 3511 and 3512 may be replaceable so as to be easily changed according to the preference of the operator, or may be configured by a ring whose size can be changed by attaching and detaching a fastener using a hook-and-loop fastener.

### E. APPLICATION EXAMPLE

### E-1. Application Example to Master Arm

FIG. 37 illustrates an application example in which the operation input device 200 according to the present embodiment is applied to a master arm 3700. The master arm 3700 includes a master arm body 3701, a device holder unit 3702 that holds the operation input device 200, two tilt links 3703 and 3704 that support the device holder unit 3702 at two locations, and a counterbalance 3705 that is attached to the master arm body 3701 on the opposite side of the device holder unit 3702 to balance the weight of the entire master arm 3700.

The device holder unit 3702 rotatably supports the operation input device 200 around a yaw axis (alternatively, the longitudinal axis of the shaft 202) in the vicinity of the drive unit 203. Furthermore, the master arm body 3701 supports the device holder unit 3702 at two positions through the two tilt links 3703 and 3704.

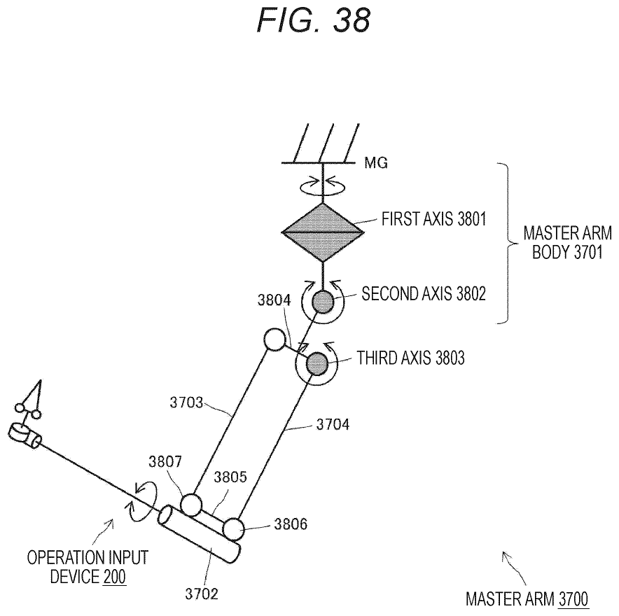

FIG. 38 illustrates a degree of freedom configuration in which the master arm 3700 supports the operation input device 200. For convenience of description, it is assumed that the master arm body 3701 is suspended from a ceiling which is a mechanical ground (MG). Furthermore, in FIG. 38, illustration of the counterbalance 3705 is omitted.

The master arm 3700 supports the operation input device 200 through a driven link 3805 of a parallel link mechanism in which the device holder unit 3702 is a driven link and the two tilt links 3703 and 3704 are intermediate links. The operation input device 200 is connected to a parallel link mechanism (alternatively, the master arm 3700) by rotating shafts 3806 and 3807 at both ends of the driven link 3805.

In addition, the master arm 3700 includes a first shaft (pan shaft) 3801 that rotates the master arm body 3701 about a vertical pan shaft with respect to a mechanical ground, a second shaft (first tilt shaft) 3802 that tilts the operation input device 200 including the parallel link mechanism (two tilt links 3703 and 3704), and a third shaft (second tilt shaft) 3803 that drives a driving link 3804 of the parallel link mechanism including the tilt links 3703 and 3704 to tilt the operation input device 200. In FIG. 38, the active joints among the joint shafts of the master arm 3700 are colored in gray. That is, the first shaft 3801, the second shaft 3802, and the third shaft 3803 are active joints, and joints other than the third shaft 3803 in the parallel link mechanism are passive joints.

The first shaft 3801 is driven, and then the operation input device 200 can be panned about the first shaft 3801. Furthermore, the second shaft 3802 is driven, and then the operation input device 200 can be tilted about the second shaft 3802 (including the parallel link mechanism including the tilt links 3703 and 3704). Furthermore, the third shaft 3803 is driven to rotate the driving link 3804 about the third shaft, and then the driven link 3805 rotates following the third shaft, so that the operation input device 200 itself can be tilted at the position suspended by the tilt links 3703 and 3704.

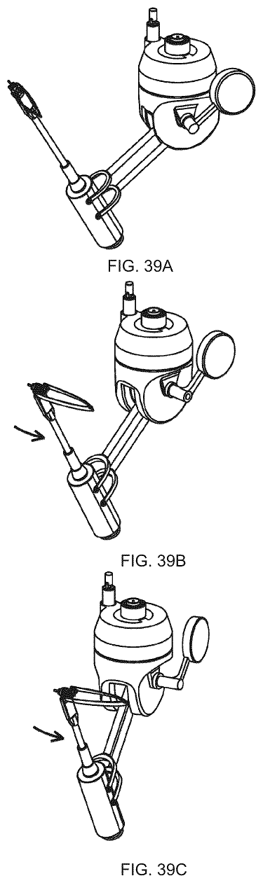

FIGS. 39(A) to 39(C) illustrate a series of operations in which the master arm 3700 pans the operation input device 200. The master arm 3700 can pan the operation input device 200 about the first shaft 3801 by driving the first shaft 3801.

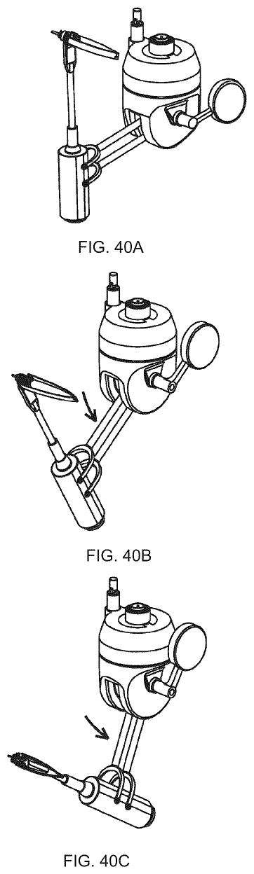

Furthermore, FIGS. 40(A) to 40(C) illustrate a series of operations in which the operation input device 200 is tilted with respect to the master arm body 3701. The master arm 3700 can tilt the operation input device 200 about the second shaft 3802 (including the parallel link mechanism including the tilt links 3703 and 3704) by driving the second shaft 3802.

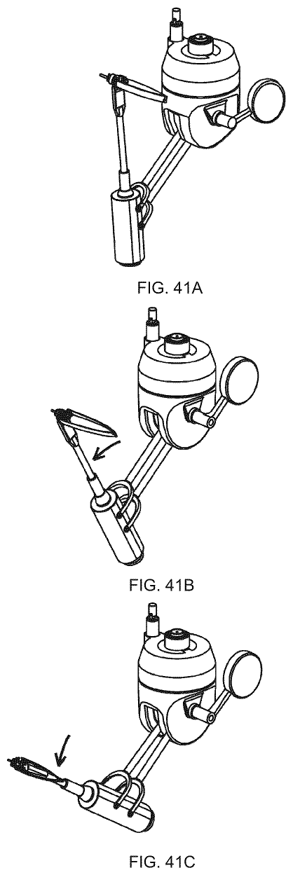

Furthermore, FIGS. 41(A) to 41(C) illustrate a series of operations in which the master arm 3700 tilts the operation input device 200 at the current position. The master arm 3700 can tilt the operation input device 200 at a position (that is, relative to the distal ends of tilt links 3703 and 3704) suspended by the tilt links 3703 and 3704 by driving the third shaft 3803 to rotate the driving link 3804 about the third shaft.

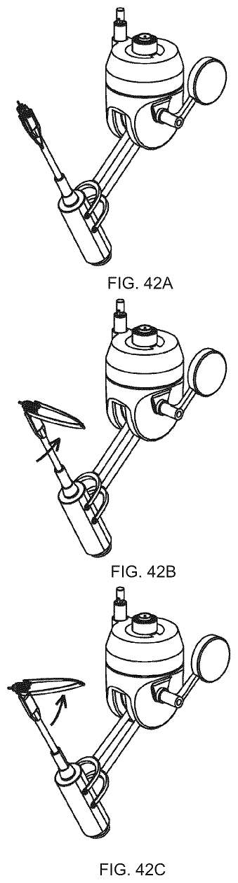

Furthermore, in the master arm 3700, the device holder unit 3702 includes a yaw axis rotation mechanism capable of rotating the operation input device 200 on the yaw axis by using a spur gear, a cable deceleration structure, or the like. To simplify the description, the detailed structure of the device holder unit 3702 is not illustrated. FIGS. 42(A) to 42(C) illustrate a series of operations in which the master arm 3700 rotates the operation input device 200 about the yaw axis.

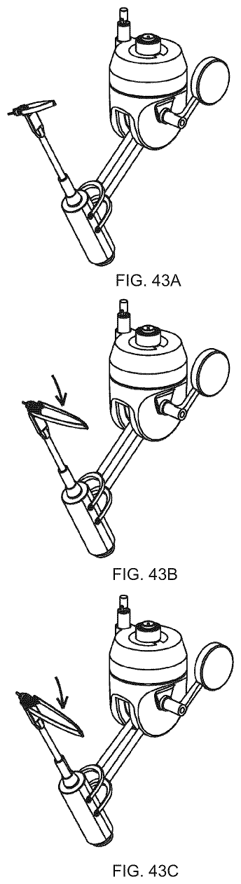

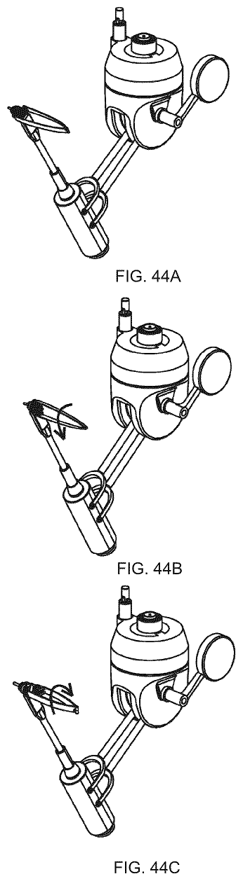

In addition, as described in item C-5 above, the operation input device 200 itself can rotate the handle portion 201 around the pitch axis and the roll axis, respectively. FIGS. 43(A) to 43(C) illustrate a series of operations in which the operation input device 200 mounted on the master arm 3700 rotates the handle portion 201 about the pitch axis. Furthermore, FIGS. 44(A) to 44(C) illustrate a series of operations in which the operation input device 200 mounted on the master arm 3700 rotates the handle portion 201 about the roll axis.

As illustrated in FIGS. 39 to 44, the operation input device 200 is mounted on the master arm 3700, so that a pan operation around the first axis, a tilt operation around the second axis, a tilt operation of the operation input device 200 itself, a rotation operation around the yaw axis of the operation input device 200, and a rotation operation around the pitch axis and the roll axis of the handle portion 201 can be realized in six degrees of freedom. In addition, the operation input device 200 can realize a total of seven degrees of freedom including the gripping operation of the handle portion 201.

Note that it is desirable that the rotation shafts 3806 and 3807 connecting the tilt links 3703 and 3704 and the device holder unit 3702 pass through the gravity center positions of the device holder unit 3702 and the operation input device 200.

In addition, a counterbalance 3705 is mounted on the opposite side of the tilt links 3703 and 3704 (alternatively, the parallel link mechanism) so as to be balanced with the moment force due to the weight of the device holder unit 3702 and the operation input device 200.

### E-2. Application Example to Operation Console Device

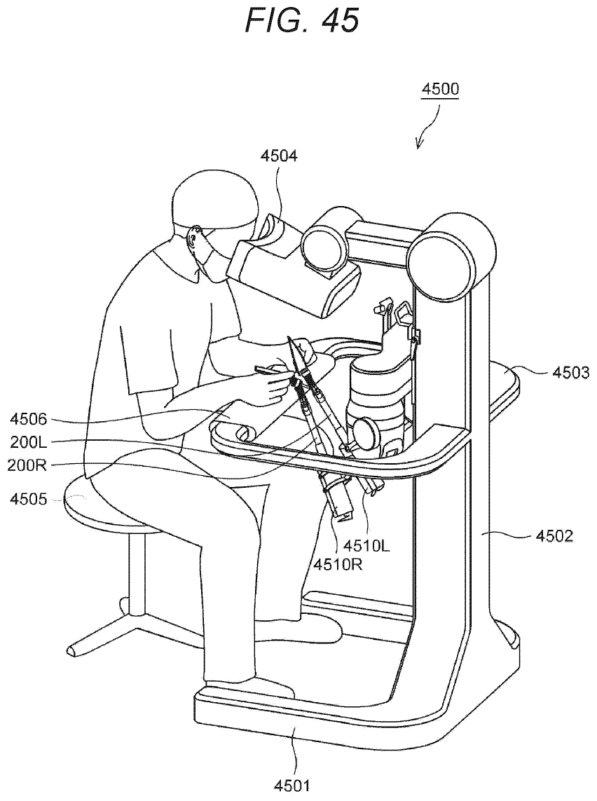

FIG. 45 illustrates an application example in which the operation input device 200 according to the present embodiment is applied to the operation console device 4500. The operation console device 4500 corresponds to a master of the master-slave surgical system 100, and is used, for example, when the operator remotely operates the surgical manipulator 122 from outside the operating room (alternatively, a place separated from the operating table in the operating room). As illustrated in FIG. 1, the operation console device 4500 includes components such as a master-side control unit 111, an operation input device 200, a presentation unit 113, and a master-side communication unit 114.

The operation console device 4500 is a structure having a substantially L shape as viewed from the side, and has a bottom portion 4501 having a U shape as viewed from the top at the lowermost end, and a base portion 4502 is connected to the center of the bottom portion 450 in a substantially vertical direction. An O-shaped or ring-shaped support portion 4503 is attached in the vicinity of the middle of the base portion 4502, and a master arm 4510R and a master arm 4510L are arranged near the root of the support portion 4503. A master arm 4510R for the operator's right hand and a master arm 4510L for the left hand are attached to an operation input device 200R and an operation input device 200L, respectively.

The operation input device 200R for the right hand, the operation input device 200L for the left hand, and the master arm 4510R and the master arm 4510L to which these devices are attached are left and right objects having the same structure. In addition, the master arm 4510R and the master arm 4510L realize six degrees of freedom of each of the operation input device 200R and the operation input device 200L as described in the above Item E-1 with reference to FIGS. 38 and 39 to 44. Furthermore, the operation input device 200R and the operation input device 200L each have a degree of freedom in gripping the handle portion 201.

Furthermore, a stereo viewer 4504 is attached to a distal end of the base portion 4502. The stereo viewer 4504 displays, for example, a 2D or 3D image of the affected part captured by the slave device 120. As a configuration in which the operator can observe the 3D image of the affected part and the master arm 4510R and the master arm 4510L can be freely arranged, it is desirable to use the stereo viewer 4504 as a display. However, a large flat panel display may be used to display the 2D or D image of the affected area.

The operation console device 4500 has substantially the same height as the operator sitting on a chair 4505. The support portion 4503 has substantially the same height as the vicinity of an elbow of the operator sitting on the chair 4505. However, the height of the chair 4505 is adjusted so that the support portion 4503 may have substantially the same height as the vicinity of the elbow of the operator. When operating the operation input device 200R for the right hand and the operation input device 200L for the left hand, the operator can use a front edge of the ring-shaped support portion 4503 for the hand rest or the wrist rest. In addition, the distal end of the base portion 4502 has substantially the same height as a head of the operator sitting on the chair 4505. The operator can operate the operation input device 200R for the right hand and the operation input device 200L for the left hand with the left and right hands while observing the 2D or 3D image of the affected part through the stereo viewer 4504.

The operation console device 4500 according to the present embodiment has the following advantages.

(1) Operation with Both Hands Close to Each Other is Possible

In the operation input device 200R and the operation input device 200L, the cable drive mechanism is applied, so that the mechanism in the vicinity of the grip portion at the arm distal end is small. Therefore, in a case where individual operation of the handle portion 201 is performed with the left and right hands, it is possible to perform the operation by bringing both hands close to each other, so that unnecessary brain conversion is unnecessary and the operator can easily perform the hand eye coordination.

### (2) Hand Rest (or Wrist Rest) is Arrangeable

Since the mechanisms in the vicinity of the handle portion 201 at the distal ends of the operation input device 200R and the operation input device 200L are small, there is no interference with peripheral mechanisms even if the front edge of the ring-shaped support portion 4503 is used for the hand rest or the wrist rest. The operator places the wrist or a part of the hand on the hand rest or the wrist rest 4506 in the environment, stabilizes the arm tip to suppress tremor, and can accurately perform fine work such as microscopic surgery.

Note that as illustrated in FIG. 45, it is desirable that the operation console device 4500 be equipped with the operation console device 4500 equipped with the operation input device 200R for the right hand and the operation console device 4500 equipped with the operation input device 200L for the left hand together. However, the operation console device may be equipped with only the operation input device 200 for one hand.

In addition, it is desirable that the operation console device 4500 include a height adjustment mechanism capable of adjusting the heights of the support portion 4503 and the stereo viewer 4504 with respect to the base portion 4502 such that the support portion 4503 has substantially the same height as the vicinity of the elbow of the operator sitting on the chair 4505 and the stereo viewer 4504 at the distal end of the base portion 4502 has substantially the same height as the head of the operator sitting on the chair 4505, or such that the support portion 4503 and the stereo viewer 4504 have heights that are preferred by the operator.

In addition, a portion of a front edge of the support portion 4503 used as the hand rest or the wrist rest 4506 with the hand or the wrist placed thereon by the operator is a portion in contact with the body of the operator, and desirably has a structure that can be easily covered with a drape or a structure in which a disposable cover can be replaced so as to always maintain cleanliness.

The operation console device 4500 can be applied to various master-slave systems. In the case of being applied to the surgical system 100 as described above, the operator can remotely operate the surgical manipulator 122 by moving the handle portions 201 of the operation input devices 200R and 200L with the left and right hands while observing the video of the microscope or the endoscope on the surgical manipulator 122 side with the stereo viewer 4504. In the case of being applied to ultrafine work such as microsurgery, the above advantages (1) and (2) are easily utilized.

The operation console device 4500 may be used for a simulator of the surgical manipulator 122 or work in a 3D video space (a virtual space such as a metaverse).

### E-3. Modification of Operation Console Device

FIG. 46 illustrates an external configuration of an operation console device 4600 according to a modification. The operation console device 4600 is configured to display a 2D or 3D image of the affected area using a large screen display 4601 instead of a stereo viewer. In addition, the master arms 4602R and 4602L respectively connecting the operation input devices 200R and 200L operated by the left and right hands are arranged in front of the large screen display 4601. Also in the case of using the operation console device 4600, the operator can observe the video of the microscope or endoscope on the surgical manipulator 122 side on the large screen display 4601, and can operate the operation input devices 200R and 200L with the left and right hands using the hand rest or the wrist rest.

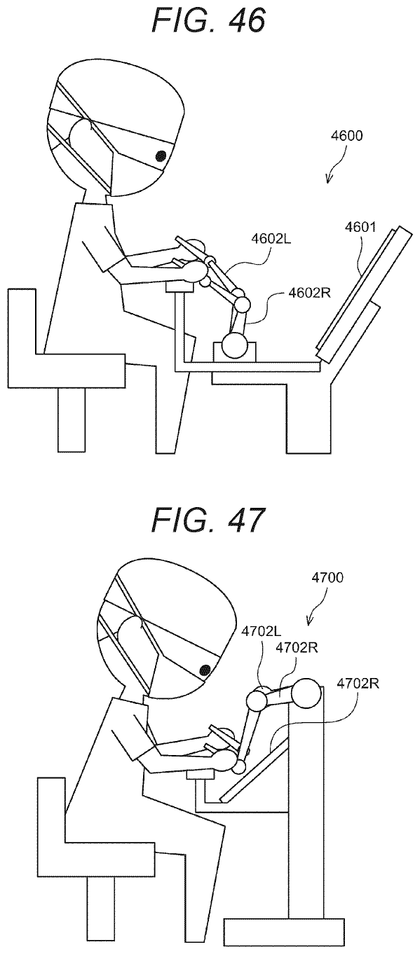

FIG. 47 illustrates an external configuration of an operation console device 4700 according to another modification. The operation console device is the same as the operation console device 4700 illustrated in FIG. 46 in that a 2D or 3D image of the affected part is displayed using the large screen display 4701 instead of the stereo viewer. However, in the operation console device 4700, the master arms 4702R and 4702L operated by the left and right hands are connected to the operation input devices 200R and 200L arranged in the vicinity of the upper portion of the large screen display 4701, respectively. In other words, the master arms 4702R and 4702L are arranged so as to overlap the screen of the display 4701. Therefore, the operator operates the operation input devices 200R and 200L while observing the image of the microscope or the endoscope through the master arms 4702R and 4702L. Also in the operation console device 4700, the operator can operate the operation input devices 200R and 200L with the left and right hands while using the hand rest or the wrist rest.

### INDUSTRIAL APPLICABILITY

The present disclosure has been described in detail with reference to the specific embodiments. However, it is obvious that those skilled in the art can make modifications and substitutions of the embodiment without departing from the scope of the present disclosure.

In the present specification, the embodiment in which the manipulator type operation input device and the operation console device according to the present disclosure are mainly applied to the master-slave surgical system has been mainly described, but the gist of the present disclosure is not limited thereto. For example, the present disclosure can be similarly applied to remote operations and 3D operations on a screen at various difficult-to-work sites such as construction sites, nuclear power plants, deep sea, and outer space. Of course, the operation input device to which the present disclosure is applied can be utilized as an input device of a personal computer, a controller of a game machine, or an operation device of a virtual reality (VR) system.

In short, the present disclosure has been described in an illustrative manner, and the contents disclosed in the present specification should not be interpreted in a limited manner. To determine the subject matter of the present disclosure, the claims should be taken into consideration.

Note that the present disclosure may also have the following configurations.

(1) An operation input device, including:
a handle portion that can be gripped and operated;
a shaft that supports the handle portion about a roll axis and a pitch axis at a distal end, and has a longitudinal axis that is a yaw axis orthogonal to the roll axis and the pitch axis; and
a cable transmission mechanism that transmits power between the handle portion and a root side of the shaft portion using a cable.

(2) The operation input device according to the above (1), further including
a drive unit that includes a first motor and a second motor and generates a drive force for a gripping operation and a rotation operation of the handle portion, in which
the cable transmission mechanism includes a first cable loop and a second cable loop that are inserted into the hollow shaft and transmit driving forces of the first motor and the second motor, respectively, and
the handle portion includes a first gripper and a second gripper that open and close, a first rotation unit that supports the first gripper and rotates about the roll axis by driving of the first cable loop, and a second rotation unit that supports the second gripper and rotates about the roll axis by driving of the second cable loop.

(3) The operation input device according to the above (2), in which
the first gripper and the second gripper simultaneously rotate about the roll axis by the first rotation unit and the second rotation unit rotating in the same direction, and
the first gripper and the second gripper open and close by the first rotation unit and the second rotation unit rotating in opposite directions.

(4) The operation input device according to the above (3), in which
when a rotation angle of the first rotation unit from a basic posture is θ₁ and a rotation angle of the second rotation unit from a basic posture is θ₂,
the first gripper and the second gripper rotate about the roll axis at a rotation angle proportional to an average of a rotation angle θ₁ of the first rotation unit and a rotation angle θ₂ of the second rotation unit, or open and close with an opening width corresponding to a difference between the rotation angle θ₁ of the first rotation unit and the rotation angle θ₂ of the second rotation unit.

(5) The operation input device according to the above (4), further including
a link mechanism that associates the first gripper and the second gripper to perform an opening/closing operation with the opening width corresponding to the difference between the rotation angle θ₁ of the first rotation unit and the rotation angle θ₂ of the second rotation unit.

(6) The operation input device according to any one of the above (2) to (5), in which
the first cable loop and the second cable loop are respectively wound around a first rotation unit and the second rotation unit at different positions sandwiching the pitch axis in a roll axis direction, and
the handle portion rotates in the pitch axis by alternately advancing and retracting the first cable loop and the second cable loop in the yaw axis direction.

(7) The operation input device according to the above (6), in which
the first motor is mounted on a first slider that slides in the yaw axis direction, and the second motor is mounted on a second slider that slides in the yaw axis direction, and
the handle portion is rotated in the pitch axis by advancing and retracting operations of the first cable loop and the second cable loop caused by alternately advancing and retracting the first slider and the second slider.

(8) The operation input device according to the above (7), further including
a third cable having one end coupled to the first slider and the other end coupled to the second slider, and a third motor that pulls the third cable in the yaw axis direction, in which
the first slider and the second slider are alternately advanced and retracted by a rotation operation of the third motor in a positive direction and an opposite direction to rotate the handle portion about the pitch axis.

(9) The operation input device according to any one of the above (1) to (8), in which
the operation input device is used by being attached to a device holder that rotates the entire operation input device about the yaw axis.

(10) The operation input device according to any one of the above (1) to (9), in which
the roll axis and the pitch axis of the handle portion are arranged in order from a distal end.

(11) The operation input device according to any one of the above (1) to (9), in which
the roll axis and the pitch axis of the handle portion are disposed to intersect with each other.

(12) The operation input device according to any one of the above (2) to (8), further including
a spring that applies a restoring force in a direction of closing the first gripper and the second gripper.

(13) The operation input device according to the above (12), in which
the first motor and the second motor are driven such that a force in an opening direction always acts on the first gripper and the second gripper.

(14) The operation input device according to any one of the above (2) to (8), in which
at least one of the first gripper and the second gripper has a fingertip holding portion into which a fingertip of an operator can be inserted.

(15) The operation input device according to the above (8), further including
a control unit that controls driving of the first to third motors.

(16) The operation input device according to the above (15), in which
the control unit controls driving of the first to third motors to present a desired sense-of-force to a hand of an operator who grips the handle portion.

(17) The operation input device according to the above (15) or (16), in which
the control unit generates a command value for a control target on a basis of a rotation angle of each output shaft of the first to third motors when an operator operates the handle portion.

(18) An operation console device including:
an operation input device corresponding to at least one of left and right hands of an operator; and
a master arm that holds the operation input device, wherein
the operation input device includes a handle portion capable of a gripping operation, a shaft that supports the handle portion about a roll axis and a pitch axis at a distal end, and a cable transmission mechanism that transmits power between the handle portion and a root side of the shaft portion using a cable.

(19) The operating console device according to the above (18), in which
the master arm includes:
a tilt link that supports the operation input device;
a panning operation unit that causes the operation input device to perform a panning operation;
a first tilting operation unit that causes the operation input device to perform a tilting operation about a vicinity of a root of the tilting link;
a second tilting operation unit that causes the operation input device to perform a tilting operation about the vicinity of the distal end of the tilting link; and
a yaw operation unit that rotates the operation input device about a yaw axis.

(20) The operating console device according to any one of the above (18) or (19), further including
a hand rest or a wrist rest on which an operator places a hand or a wrist when operating the operation input device.

### REFERENCE SIGNS LIST

100 Surgical system
110 Operation console device
111 Master-side control unit
113 Presentation unit
114 Master-side communication unit
120 Slave device
121 Slave-side control unit
122 Surgical manipulator
123 Sensor unit
124 Slave-side communication unit
130 Transmission path
200 Operation input device
201 Handle portion
202 Shaft
202a Socket
202b Base
202c Shaft hole
203 Drive unit
204 Wrist element
204a Bearing
204b Protrusion
211 First gripper
212 Second gripper
231 First motor
232 Second motor
233 Third motor
241 First cable
242 Second cable loop
243 Third cable
251 First input capstan
252 Second input capstan
253 Third input capstan
261 First output capstan
261a Shaft portion
261b Rotor
262 Second output capstan
262a Bearing
501, 502, 503, 504 Protrusion
511, 512, 513, 514 Link
521, 522 Rotary joint
601 First slider
602 Second slider
2700 Device holder
2701 Drive mechanism unit
2702, 2703 Tilting link
3401 Torsion spring
3500 Handle portion (modification)
3501 First gripper
3502 Second gripper
3511 Fingertip holding portion
3512 Fingertip holding portion
3700 Master arm
3701 Master arm body
3702 Device holder portion
3703, 3704 Tilting link
3705 Counterbalance
3801 First shaft (pan shaft)
3802 Second shaft (tilt shaft)
3803 Third axis (second tilt axis)
3804 Motor rink
3805 Driven link
3806, 3807 Rotation shaft
4500 Operation console device
4501 Bottom
4502 Base portion
4503 Support portion
4504 Stereo viewer
4505 Chair
4506 Hand rest or wrist rest
4510 Master arm
4600 Operation console device
4601 Large-screen display
4602 Master arm
4700 Operation console device
4701 Large-screen display
4702 Master arm

1. An operation input device, comprising:
a handle portion that can be gripped and operated;
a shaft that supports the handle portion about a roll axis and a pitch axis at a distal end, and has a longitudinal axis that is a yaw axis orthogonal to the roll axis and the pitch axis; and
a cable transmission mechanism that transmits power between the handle portion and a root side of the shaft portion using a cable.
a plurality of motors,

2. The operation input device according to claim 1, further comprising
a drive unit that includes a first motor and a second motor and generates a drive force for a gripping operation and a rotation operation of the handle portion, wherein
the cable transmission mechanism includes a first cable loop and a second cable loop that are inserted into the hollow shaft and transmit driving forces of the first motor and the second motor, respectively, and
the handle portion includes a first gripper and a second gripper that open and close, a first rotation unit that supports the first gripper and rotates about the roll axis by driving of the first cable loop, and a second rotation unit that supports the second gripper and rotates about the roll axis by driving of the second cable loop.

3. The operation input device according to claim 2, wherein
the first gripper and the second gripper simultaneously rotate about the roll axis by the first rotation unit and the second rotation unit rotating in the same direction, and
the first gripper and the second gripper open and close by the first rotation unit and the second rotation unit rotating in opposite directions.

4. The operation input device according to claim 3, wherein
when a rotation angle of the first rotation unit from a basic posture is θ₁ and a rotation angle of the second rotation unit from a basic posture is θ₂,
the first gripper and the second gripper rotate about the roll axis at a rotation angle proportional to an average of a rotation angle θ₁ of the first rotation unit and a rotation angle θ₂ of the second rotation unit, or open and close with an opening width corresponding to a difference between the rotation angle θ₁ of the first rotation unit and the rotation angle θ₂ of the second rotation unit.

5. The operation input device according to claim 4, further comprising
a link mechanism that associates the first gripper and the second gripper to perform an opening/closing operation with the opening width corresponding to the difference between the rotation angle θ₁ of the first rotation unit and the rotation angle θ₂ of the second rotation unit.

6. The operation input device according to claim 2, wherein
the first cable loop and the second cable loop are respectively wound around a first rotation unit and the second rotation unit at different positions sandwiching the pitch axis in a roll axis direction, and
the handle portion rotates in the pitch axis by alternately advancing and retracting the first cable loop and the second cable loop in the yaw axis direction.

7. The operation input device according to claim 6, wherein
the first motor is mounted on a first slider that slides in the yaw axis direction, and the second motor is mounted on a second slider that slides in the yaw axis direction, and
the handle portion is rotated in the pitch axis by advancing and retracting operations of the first cable loop and the second cable loop caused by alternately advancing and retracting the first slider and the second slider.

8. The operation input device according to claim 7, further comprising
a third cable having one end coupled to the first slider and the other end coupled to the second slider, and a third motor that pulls the third cable in the yaw axis direction, wherein
the first slider and the second slider are alternately advanced and retracted by a rotation operation of the third motor in a positive direction and an opposite direction to rotate the handle portion about the pitch axis.

9. The operation input device according to claim 1, wherein
the operation input device is used by being attached to a device holder that rotates the entire operation input device about the yaw axis.

10. The operation input device according to claim 1, wherein
the roll axis and the pitch axis of the handle portion are arranged in order from a distal end.

11. The operation input device according to claim 1, wherein
the roll axis and the pitch axis of the handle portion are disposed to intersect with each other.

12. The operation input device according to claim 2, further comprising
a spring that applies a restoring force in a direction of closing the first gripper and the second gripper.

13. The operation input device according to claim 12, wherein
the first motor and the second motor are driven such that a force in an opening direction always acts on the first gripper and the second gripper.

14. The operation input device according to claim 2, wherein
at least one of the first gripper and the second gripper has a fingertip holding portion into which a fingertip of an operator can be inserted.

15. The operation input device according to claim 8, further comprising
a control unit that controls driving of the first to third motors.

16. The operation input device according to claim 15, wherein
the control unit controls driving of the first to third motors to present a desired sense-of-force to a hand of an operator who grips the handle portion.

17. The operation input device according to claim 15, wherein
the control unit generates a command value for a control target on a basis of a rotation angle of each output shaft of the first to third motors when an operator operates the handle portion.

18. An operation console device, comprising:
an operation input device corresponding to at least one of left and right hands of an operator; and
a master arm that holds the operation input device, wherein
the operation input device includes a drive unit that generates a driving force for a gripping operation and a rotating operation of the handle portion using a handle portion capable of a gripping operation and a shaft that supports the handle portion about a roll axis and a pitch axis at a distal end, and a cable transmission mechanism that transmits power between the handle portion and a root side of the shaft portion using a cable.

19. The operating console device of claim 18, wherein
the master arm includes:
a tilt link that supports the operation input device;
a panning operation unit that causes the operation input device to perform a panning operation;
a first tilting operation unit that causes the operation input device to perform a tilting operation about a vicinity of a root of the tilting link;
a second tilting operation unit that causes the operation input device to perform a tilting operation about the vicinity of the distal end of the tilting link; and
a yaw operation unit that rotates the operation input device about a yaw axis.

20. The operating console device of claim 18, further comprising
a hand rest or a wrist rest on which an operator places a hand or a wrist when operating the operation input device.
